(19) United States
(12) Patent Application Publication
(10) Pub. No.: US 2016/0059549 A1
(43) Pub. Date: Mar. 3, 2016

(54) LIQUID EJECTING DEVICE, METHOD OF CONTROLLING LIQUID EJECTION DEVICE, AND CONTROL PROGRAM OF LIQUID EJECTING DEVICE

(71) Applicant: SEIKO EPSON CORPORATION, Tokyo (JP)

(72) Inventors: Masashi KAMIYANAGI, Suwa-shi (JP); Toshiyuki Suzuki, Matsumoto-shi (JP); Osamu Shinkawa, Chino-shi (JP)

(73) Assignee: SEIKO EPSON CORPORATION, Tokyo (JP)

(21) Appl. No.: 14/835,838

(22) Filed: Aug. 26, 2015

(30) Foreign Application Priority Data
Aug. 29, 2014 (JP) 2014-175740

(51) Int. Cl. B41J 2/045

(52) U.S. Cl. CPC B41J 2/04588; B41J 2/04581

(57) ABSTRACT

A liquid ejecting device including: an ejection unit that includes a piezoelectric element which is shifted according to a driving signal, and a nozzle that ejects a liquid which the shift of the piezoelectric element; a generating unit that generates the driving signal based on a designation signal; a supply unit that supplies the designation signal to the generating unit; a detecting unit that detects residual vibration generated in the ejection unit after the piezoelectric element is shifted according to the driving signal; and a determining unit that determines an ejection state of the liquid in the ejection unit based on the detection results of the detecting unit, in which the detecting unit detects the residual vibration during a detection period, and the supply unit supplies the designation signal to the generating unit during a period other than the detection period.

This application claims priority to Japanese Patent Application No. 2014-175740 filed on Aug. 29, 2014. The entire disclosure of Japanese Patent Application No. 2014-175740 is hereby incorporated herein by reference.

### BACKGROUND

1. Technical Field

The present invention relates to a liquid ejecting device, a method of controlling a liquid ejecting device, and a control program of a liquid ejecting device.

2. Related Art

In a liquid ejecting device such as an ink jet printer that allows an ejection unit to eject an ink and forms an image on a medium, there is a case in which ejection abnormality in which an ink cannot be normally ejected from an ejection unit occurs due to thickening of the ink or mixture of bubbles. When ejection abnormality occurs in an ejection unit, dots which are expected to be formed by the ink ejected from the ejection unit are not accurately formed and the image quality of an image to be formed on a medium is degraded.

In order to prevent degradation of the image quality caused by ejection abnormality, techniques of detecting ejection abnormality by detecting residual vibration generated in an ejection unit after the ejection unit is driven and determining an ejection state of an ink ejected from the ejection unit based on the detected residual vibration have been suggested (for example, JP-A-2004-276544).

However, the residual vibration generated in the ejection unit is detected as a signal having a small amplitude such as a signal showing a change in electromotive force of a piezoelectric element included in the ejection unit. For this reason, a signal showing residual vibration is easily affected by noise. In addition, in a case where noise is superimposed on the signal showing the residual vibration, a possibility in which the residual vibration cannot be accurately detected becomes high and the ejection state of an ink in the ejection unit cannot be accurately determined.

### SUMMARY

An advantage of some aspects of the invention is to provide a technique of improving accuracy of determination of an ejection state of an ink ejected from an ejection unit.

According to an aspect of the invention, there is provided a liquid ejecting device including: an ejection unit that includes a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber; a generating unit that generates the driving signal based on a driving waveform signal having one or a plurality of waveforms and a designation signal designating a waveform to be supplied to the piezoelectric element from one or the plurality of waveforms included in the driving waveform signal; a supply unit that supplies the designation signal to the generating unit for each unit period; a detecting unit that detects residual vibration generated in the ejection unit after the piezoelectric element is shifted according to the driving signal; and a determining unit that determines an ejection state of the liquid in the ejection unit based on the detection results of the detecting unit, in which the detecting unit detects the residual vibration during a detection period in the unit period, and the supply unit supplies the designation signal to the generating unit during a period other than the detection period in the unit period.

According to the invention, residual vibration generated in an ejection unit is detected during a period other than the period for which the designation signal is supplied to the generating unit. Accordingly, it is possible to prevent noise caused by the designation signal, such as noise generated due to a change in a signal level of the designation signal, from being superimposed on the residual vibration. In this manner, the ejection state of a liquid in the ejection unit can be accurately determined compared to a case where the designation signal is supplied to the generating unit during at least a part of the period for which the residual vibration is detected.

In the liquid ejecting device, the supply unit may supply the designation signal to the generating unit during a first period which is a period after the detection period in the unit period is finished.

According to the aspect of the invention, since the residual vibration generated in the ejection unit is detected during the period other than the period for which the designation signal is supplied to the generating unit, the ejection state of the liquid in the ejection unit can be accurately determined.

In the liquid ejecting device, when supplied to the piezoelectric element, the driving waveform signal may include a microvibration waveform that shifts the piezoelectric element to the extent that the liquid cannot be ejected from the nozzle, and the microvibration waveform may be provided during the first period.

According to the aspect of the invention, since a microvibration waveform is supplied during the first period subsequent to the detection period, it is possible to prevent the vibration, caused by the microvibration waveform being supplied, from being superimposed on the residual vibration generated in the ejection unit. Accordingly, the ejection state of the liquid in the ejection unit can be accurately determined.

In the liquid ejecting device, the supply unit may supply the designation signal to the generating unit during a second period which is a period before the detection period in the unit period is started.

According to the aspect of the invention, since the residual vibration generated in the ejection unit is detected during the period other than the period for which the designation signal is supplied to the generating unit, the ejection state of the liquid in the ejection unit can be accurately determined.

In the liquid ejecting device, the supply unit may supply the designation signal to the generating unit during a first period which is a period after the detection period in the unit period is finished and during a second period which is a period before the detection period in the unit period is started.

According to the aspect of the invention, since the residual vibration generated in the ejection unit is detected during the period other than the period for which the designation signal is supplied to the generating unit, the ejection state of the liquid in the ejection unit can be accurately determined.

Further, according to the aspect of the invention, since the designation signal is supplied both before the detection period is started and after the detection period is finished, the designation signal can be supplied to the generating unit even in a case where the liquid ejecting device is operated at high speed so that the time length of the unit period becomes shorter. In other words, according to the aspect of the invention, it is possible to speed up the operation of the liquid ejecting device.

According to another aspect of the invention, there is provided a method of controlling a liquid ejecting device which has an ejection unit including a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber; and a generating unit that generates the driving signal based on a driving waveform signal having one or a plurality of waveforms and a designation signal designating a waveform to be supplied to the piezoelectric element from one or the plurality of waveforms included in the driving waveform signal, the method including: supplying the designation signal to the generating unit for each unit period; detecting residual vibration generated in the ejection unit after the piezoelectric element is shifted according to the driving signal; and determining an ejection state of the liquid in the ejection unit based on the detection results of the residual vibration, in which the detecting of the residual vibration is performed during a detection period in the unit period, and the supplying of the designation signal is performed during a period other than the detection period in the unit period.

According to the invention, the residual vibration generated in the ejection unit is detected during the period other than the period for which the designation signal is supplied to the generating unit. Accordingly, it is possible to prevent the noise caused by the designation signal from being superimposed on the residual vibration. In this manner, the ejection state of a liquid in the ejection unit can be accurately determined compared to a case where the designation signal is supplied to the generating unit during at least a part of the period for which the residual vibration is detected.

According to still another aspect of the invention, there is provided a control program of a liquid ejecting device which has an ejection unit including a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber; a generating unit that generates the driving signal based on a driving waveform signal having one or a plurality of waveforms and a designation signal designating a waveform to be supplied to the piezoelectric element from one or the plurality of waveforms included in the driving waveform signal; a detecting unit that detects the residual vibration generated in the ejection unit after the piezoelectric element is shifted according to the driving signal; and a computer, the program causing the computer to function as: a supply unit that supplies the designation signal to the generating unit for each unit period; and a determining unit that determines an ejection state of the liquid in the ejection unit based the detection results of the detection unit, in which the detecting unit detects the residual vibration during a detection period in the unit period, and the supply unit supplies the designation signal to the generating unit during a period other than the detection period in the unit period.

According to the invention, the residual vibration generated in the ejection unit is detected during the period other than the period for which the designation signal is supplied to the generating unit. Accordingly, it is possible to prevent the noise caused by the designation signal from being superimposed on the residual vibration. In this manner, the ejection state of a liquid in the ejection unit can be accurately determined compared to a case where the designation signal is supplied to the generating unit during at least a part of the period for which the residual vibration is detected.

### BRIEF DESCRIPTION OF THE DRAWINGS

The invention will be described with reference to the accompanying drawings, wherein like numbers reference like elements.

FIG. 1 is a block diagram illustrating the outline of a configuration of a printing system according to an embodiment of the invention.

FIG. 2 is a partial cross-sectional view schematically illustrating an ink jet printer.

FIG. 3 is a cross-sectional view schematically illustrating a recording head.

FIG. 4 is a plan view illustrating an arrangement example of nozzles in the recording head.

FIGS. 5A to 5C are explanatory diagrams for describing a change in the shape of a cross section of an ejection unit when a driving signal is supplied.

FIG. 6 is a circuit diagram illustrating a model of simple vibration showing residual vibration in the ejection unit.

FIG. 7 is a graph illustrating a relationship between a test value and a calculated value of residual vibration in a case where an ejection state of the ejection unit is normal.

FIG. 8 is an explanatory diagram illustrating the state of the ejection unit in a case where bubbles are mixed into the inside of the ejection unit.

FIG. 9 is a graph illustrating the test value and the calculated value of the residual vibration in the state in which bubbles are mixed into the inside of the ejection unit.

FIG. 10 is an explanatory diagram illustrating the state of the ejection unit in a case where the ink is fixed in the vicinity of a nozzle.

FIG. 11 is a graph illustrating the test value and the calculated value of the residual vibration in a state in which the ink cannot be ejected due to the fixation of the ink in the vicinity of the nozzle.

FIG. 12 is an explanatory diagram illustrating the state of the ejection unit in a case where paper dust adheres to the vicinity of an outlet of the nozzle.

FIG. 13 is a graph illustrating the test value and the calculated value of the residual vibration in a state in which the ink cannot be ejected due to the adhesion of paper dust to the vicinity of the outlet of the nozzle.

FIG. 14 is a block diagram illustrating a configuration of a driving signal generating unit.

FIGS. 15A and 15B are explanatory diagrams illustrating decoded contents of a decoder.

FIG. 16 is a timing chart illustrating an operation of the driving signal generating unit.

FIG. 17 is a timing chart illustrating an operation of the driving signal generating unit.

FIG. 18 is a timing chart illustrating a waveform of a driving signal.

FIG. 19 is a block diagram illustrating a configuration of a residual vibration detecting unit, a switching unit, and an ejection state determining unit.

FIG. 20 is a timing chart illustrating an operation of a measuring unit.

FIG. 21 is an explanatory diagram for describing determination information.

FIG. 22 is a timing chart illustrating an operation of a driving signal generating unit according to Modification Example 1.

FIG. 23 is a timing chart illustrating the operation of the driving signal generating unit according to Modification Example 1.

### DESCRIPTION OF EXEMPLARY EMBODIMENTS

Hereinafter, embodiments for implementing the present invention will be described with reference to the accompanying drawings. However, throughout the drawings, dimensions and scales of the respective parts are appropriately different from those of actual parts. Moreover, since embodiments described herein are preferred concrete examples of the present invention, the embodiments are provided with various limitations that are technologically preferred, but the scope of the present invention is not limited to the embodiments unless there is a disclosure which particularly limits the present invention in the following description.

### A. EMBODIMENT

In the present embodiment, a liquid ejecting device will be described by exemplifying an ink jet printer which ejects an ink (an example of a “liquid”) to form an image on recording paper P (an example of a “medium”).

### 1. Outline of Printing System

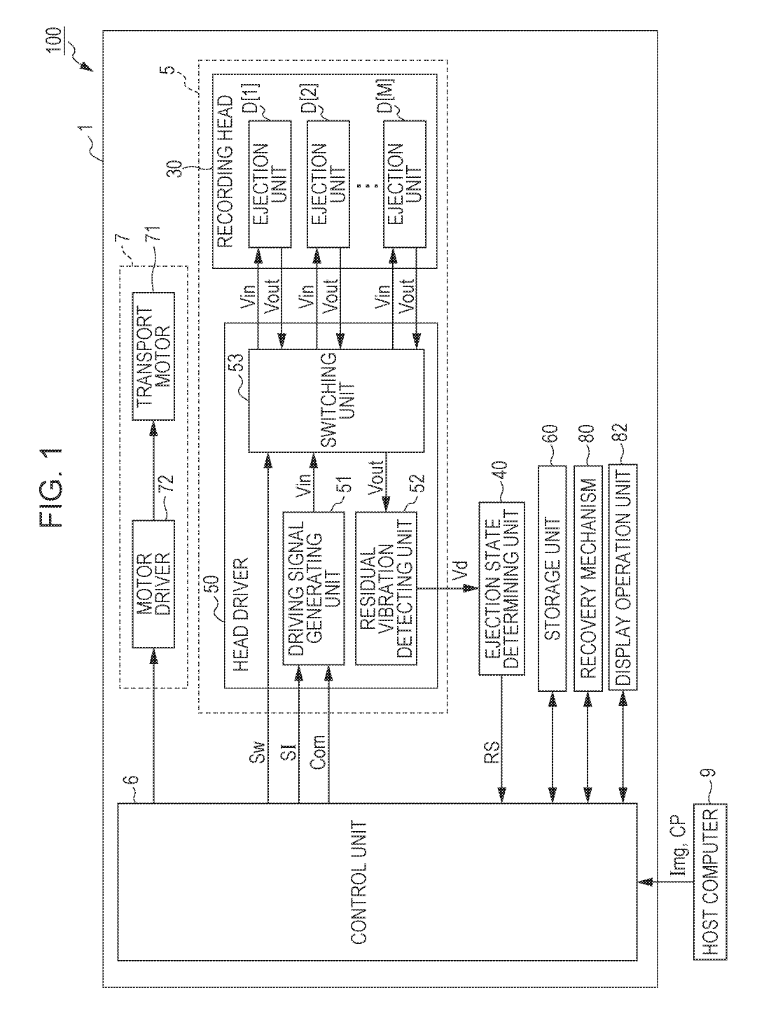

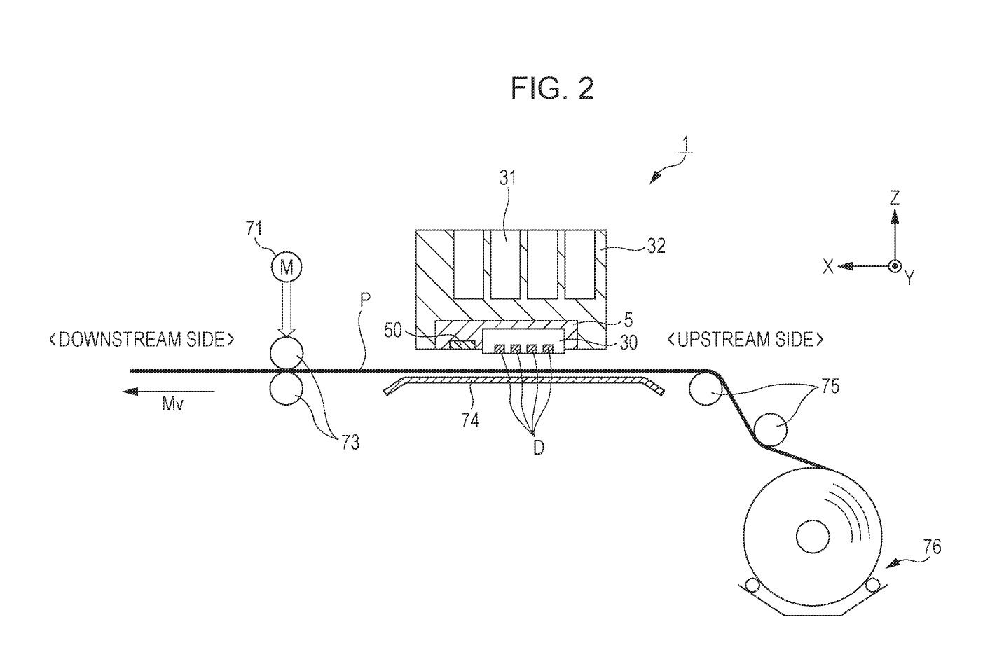

A configuration of an ink jet printer 1 according to the present embodiment will be described with reference to FIGS. 1 and 2.

FIG. 1 is a block diagram illustrating a configuration of a printing system 100 which includes an ink jet printer 1. The printing system 100 includes a host computer 9 such as a personal computer or a digital camera, and an ink jet printer 1.

The host computer 9 outputs print data Img showing an image to be formed (printed) by the ink jet printer 1 and print copy information CP showing the number Wcp of print copies of an image to be formed by the ink jet printer 1.

The ink jet printer 1 performs a printing process of forming an image shown by the print data Img to be supplied from the host computer 9 on recording paper P by the number Wcp of print copies shown by the print copy information CP. Hereinafter, a series of processes from when the ink jet printer 1 receives the print data Img and the print copy information CP to when the printing process of forming the image shown by the print data Img by the number Wcp of print copies shown by the print copy information CP is completed are referred to as a print job.

Further, in the present embodiment, description is made by exemplifying a case where the ink jet printer 1 is a line printer.

As illustrated in FIG. 1, the ink jet printer 1 includes a head unit 5 for which an ejection unit D ejecting an ink is provided; an ejection state determining unit 40 (an example of a “determining unit”) that determines an ejection state of the ink from the ejection unit D; a transport mechanism 7 for changing a relative position of the recording paper P with respect to the head unit 5; a control unit 6 that controls operations of respective units of the ink jet printer 1; a storage unit 60 that stores a control program of the ink jet printer 1 or other pieces of information; a recovery mechanism 80 that performs a maintenance process for recovering the ejection state of the ink in the ejection unit D into a normal state in a case where ejection abnormality is detected in the ejection unit D; a display unit that displays an error message or the like formed of a liquid crystal display or an LED lamp; and a display operating unit 82 that includes an operating unit for inputting various commands or the like to the ink jet printer 1 by a user of the ink jet printer 1.

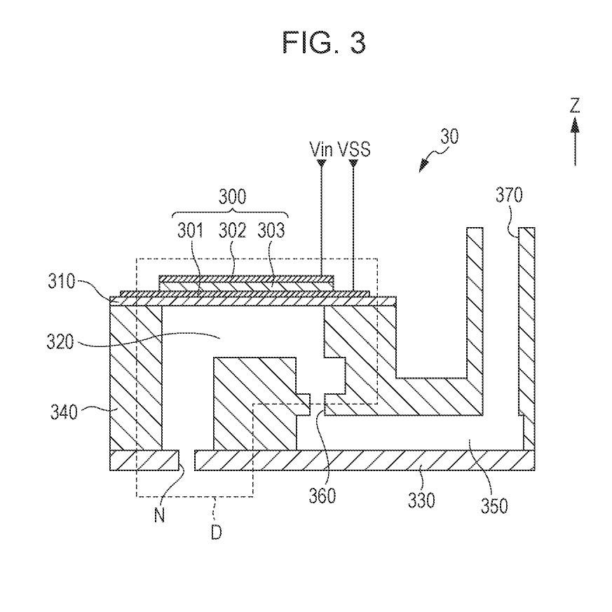

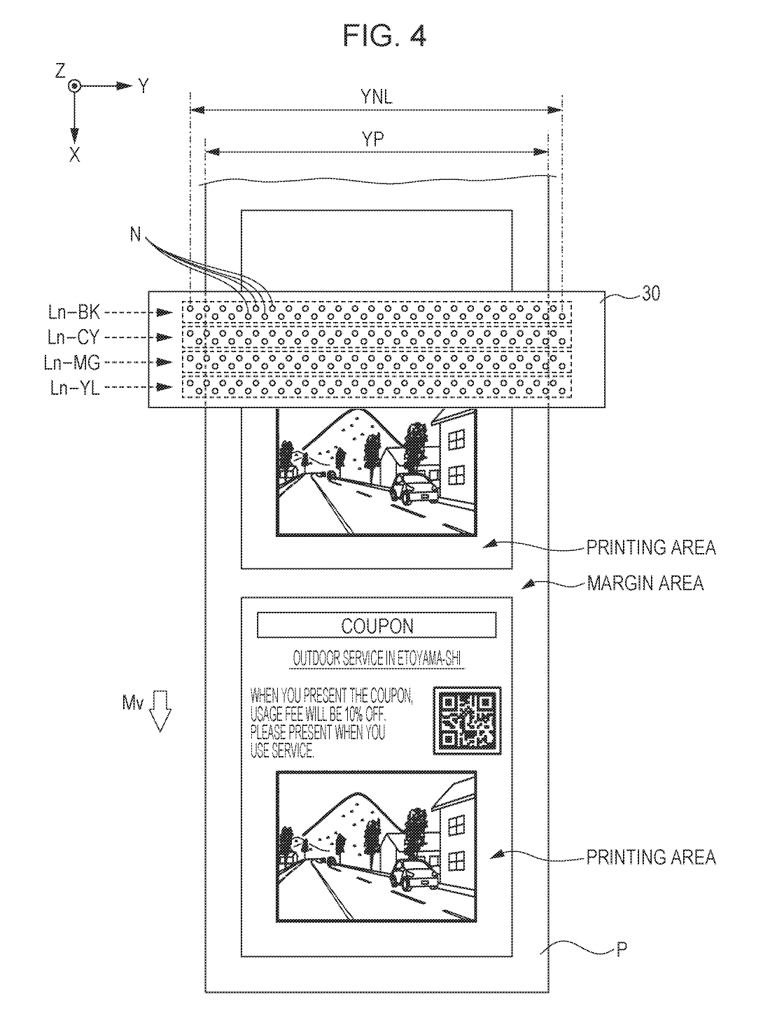

Here, ejection abnormality is a general term for a state in which an ejection state of an ink in the ejection unit D is abnormal, that is, a state in which the ink cannot be accurately ejected from a nozzle N (see FIGS. 3 and 4 described below) included in the ejection unit D.

More specifically, the ejection abnormality includes a state in which the ejection unit D cannot eject an ink; a state in which the ejection unit D cannot eject an ink of an amount necessary for forming an image shown by the print data Img because the amount of the ink to be ejected is small even when the ink can be ejected from the ejection unit D; a state in which an ink of an amount more than necessary for forming an image shown by the print data Img is ejected from the ejection unit D; and a state in which an ink ejected from the ejection unit D impacts on a position different from the impact position prepared for forming an image shown by the print data Img.

Further, the maintenance process is a general term including a wiping process of wiping foreign matters such as paper dust or the like adhered to the vicinity of the nozzle N of the ejection unit D using a wiper (not illustrated); a flushing process of allowing an ink to be preliminarily ejected from the ejection unit D; an absorbing process of absorbing an ink which has thickened in the ejection unit D or bubbles using a tube pump (not illustrated); and a process of retuning the ejection state of an ink of the ejection unit D into a normal state.

FIG. 2 is a partial cross-sectional view schematically illustrating the internal configuration of the ink jet printer 1.

As illustrated in FIG. 2, the ink jet printer 1 includes a carriage 32 on which the head unit 5 is mounted. Four ink cartridges 31 are mounted on the carriage 32 in addition to the head unit 5.

Four ink cartridges 31 are provided in one-to-one correspondence with four colors (CMYK) of black (BK), cyan (CY), magenta (MG), and yellow (YL) and the respective ink cartridges 31 are filled with inks of colors corresponding to the ink cartridges 31. In addition, each of the ink cartridges 31 may be provided in a different area of the ink jet printer 1 instead of being mounted on the carriage 32.

As illustrated in FIG. 1, the transport mechanism 7 includes a transport motor 71 serving as a driving source for transporting the recording paper P and a motor driver 72 for driving the transport motor 71.

Further, as illustrated in FIG. 2, the transport mechanism 7 includes a platen 74 provided on the lower side (−Z direction in FIG. 2) of the carriage 32; a transport roller 73 rotating by the operation of the transport motor 71; a guide roller 75 provided so as to be freely rotatable around a Y axis in FIG. 2; and a storing unit 76 that stores the recording paper P in a state of winding the recording paper in a roll shape.

The transport mechanism 7 transports the recording paper P to a +X direction (to the downstream side from the upstream side) at a transporting speed My in the figure along a transport path regulated by the guide roller 75, the platen 74, and the transport roller 73 after the recording paper P is drawn out from the storing unit 76 in a case where the ink jet printer 1 performs the printing process.

The storage unit 60 includes an electrically erasable programmable read-only memory (EEPROM) which is a kind of non-volatile semiconductor memory that stores the print data Img supplied from the host computer 9, a random access memory (RAM) that temporarily stores data required to perform various processes such as a printing process and the like and temporarily develops a control program for executing various processes such as a printing process and the like, and a PROM which is a kind of non-volatile semiconductor memory that stores the control program for controlling respective units of the ink jet printer 1.

The control unit 6 includes a central processing unit (CPU) or a field-programmable gate array (FPGA) and controls operations of respective units of the ink jet printer 1 by the CPU or the like being operated according to a control program stored in the storage unit 60.

The control unit 6 controls execution of the printing process of forming an image on the recording paper P according to the print data Img by controlling the head unit 5 and the transport mechanism 7 based on the print data Img supplied from the host computer 9.

Specifically, the control unit 6 stores the print data Img supplied from the host computer 9 in the storage unit 60. Next, the control unit 6 generates signals such as a printing signal SI (an example of the “designation signal”) and a driving waveform signal Com for driving the ejection unit D by controlling the operation of the head unit 5 based on various kinds of data stored in the storage unit 60 such as print data Img. Further, the control unit 6 generates print data SI and signals for controlling the operation of the motor driver 72 based on the various kinds of data stored in the storage unit 60 and outputs the generated various signals. In addition, the driving waveform signals Com according to the present embodiment include driving waveform signals Com-A and Com-B and the details will be described below.

As described above, the control unit 6 drives the transport motor 71 such that the recording paper P is transported to the +X direction by controlling the motor driver 72 and controls presence of ink ejection from the ejection unit D, the amount of the ink to be ejected, and the timing of ejecting an ink by controlling the head unit 5. In this manner, the control unit 6 adjusts the size and the arrangement of dots to be formed by the ink ejected onto the recording paper P and controls execution of the printing process of forming an image corresponding to the print data Img on the recording paper P.

In addition, although the details will be described below, the control unit 6 controls execution of an ejection state determining process of determining whether the ejection state of the ink ejected from respective ejection units D is normal.

As illustrated in FIG. 1, the head unit 5 includes a recording head 30 having M ejection units D and a head driver 50 that drives respective ejection units D included in the recording head 30 (in the present embodiment, M is a natural number of 4 or higher).

In addition, in order to distinguish each of the M ejection units D, expressions of a first stage, a second stage, . . . , an M-th stage in order from the top are used. Further, hereinafter, the ejection units D of the m-th stage are expressed as ejection units D[m] in some cases (the variable m is a natural number satisfying an expression of “1≦m≦M”).

Each of the M ejection units D receives supply of the ink from any of four ink cartridges 31. The inside of each of the ejection units D is filled with an ink supplied from the ink cartridge 31 and the ink filling the inside thereof can be ejected from the nozzle N included in the ejection unit D. Further, each ejection unit D forms an image on the recording paper P by ejecting the ink to the recording paper P at the timing at which the transport mechanism 7 transports the recording paper P to the platen 74. In this manner, four colors of inks of CMYK can be ejected from the M ejection units D as a whole, so that full color printing is realized.

The head driver 50 includes a driving signal generating unit 51 (an example of the “generating unit”), a residual vibration detecting unit 52 (an example of the “detecting unit”), and a switching unit 53.

The driving signal generating unit 51 generates a driving signal Vin for driving each of the M ejection units D included in the recording head 30 based on signals supplied from the control unit 6 such as the print signal SI and the driving waveform signal Com output by the control unit 6 and supplies the generated driving signal Vin to the ejection unit D through the switching unit 53. When the driving signal Vin is supplied, each ejection unit D is driven based on the supplied driving signal Vin and an ink filling the inside thereof can be ejected onto the recording paper P.

The residual vibration detecting unit 52 detects, as a residual vibration signal Vout, residual vibration generated in the ejection unit D after the ejection unit D is driven by the driving signal Vin. Moreover, the residual vibration detecting unit 52 generates a waveform shaping signal Vd and outputs the generated waveform shaping signal Vd as a detection result of the residual vibration in the ejection unit D by performing processes of removing a noise component or amplifying a signal level with respect to the detected residual vibration signal Vout.

The switching unit 53 electrically connects the respective ejection units D to any one of the driving signal generating unit 51 or the residual vibration detection unit 52, based on the switching control signal Sw supplied from the control unit 6.

In addition, in the present embodiment, the driving signal generating unit 51, the residual vibration detecting unit 52, and the switching unit 53 are implemented, as electronic circuits, on a substrate to be provided in the head unit 5.

The ejection state determining unit 40 determines the ejection state of the ink in the ejection unit D and generates determination information RS showing the determination results based on the waveform shaping signal Vd output by the residual vibration detecting unit 52.

Further, in the present embodiment, the ejection state determining unit 40 is implemented as an electronic circuit on a substrate provided on a position different from that of the head unit 5.

### 2. Configuration of Recording Head

The recording head 30 and the ejection unit D provided in the recording head 30 will be described with reference to FIGS. 3 and 4.

FIG. 3 is an example of a partial cross-sectional view schematically illustrating the recording head 30. Further, for convenience of illustration, in the recording head 30, one ejection unit D among M ejection units D included in the recording head 30; a reservoir 350 communicating with the one ejection unit D through an ink supply port 360; and an ink inlet 370 for supplying an ink to the reservoir 350 from the ink cartridge 31 are illustrated in the figure.

As illustrated in FIG. 3, the ejection unit D includes a piezoelectric element 300; a cavity 320 (an example of the “pressure chamber”) whose inside is filled with an ink; the nozzle N communicating with the cavity 320; and a vibration plate 310. In the ejection unit D, the ink in the cavity 320 is ejected from the nozzle N by the piezoelectric element 300 being driven by the driving signal Vin. The cavity 320 of the ejection unit D is a space divided by a cavity plate 340 formed to have a predetermined shape with a concave portion formed therein, a nozzle plate 330 on which the nozzle N is formed, and a vibration plate 310. The cavity 320 communicates with the reservoir 350 through the ink supply port 360. The reservoir 350 communicates with one ink cartridge 31 through the ink inlet 370.

In the present embodiment, a unimorph (monomorph) type as illustrated in FIG. 3 is employed as the piezoelectric element 300. In addition, the piezoelectric element 300 is not limited to the unimorph type and may employ any form such as a bimorph type or a lamination type as long as a liquid such as an ink can be ejected by deforming the piezoelectric element 300.

The piezoelectric element 300 includes a lower electrode 301, an upper electrode 302, and a piezoelectric body 303 provided between the lower electrode 301 and the upper electrode 302. In addition, when a voltage is applied to a space between the lower electrode 301 and the upper electrode 302 by the lower electrode 301 being set to have a predetermined reference potential VSS and the driving signal Vin being supplied to the upper electrode 302, the piezoelectric element 300 is deflected (shifted) in the vertical direction in response to the applied voltage and, as a result, the piezoelectric element 300 vibrates.

The vibration plate 310 is disposed in the opening portion of the upper surface of the cavity plate 340 and the lower electrode 301 is bonded to the vibration plate 310. Accordingly, when the piezoelectric element 300 vibrates due to the driving signal Vin, the vibration plate 310 vibrates. Further, the volume of the cavity 320 (pressure in the cavity 320) is changed due to the vibration of the vibration plate 310 and the ink filled in the cavity 320 is ejected by the nozzle N. In the case where the ink in the cavity 320 is reduced due to ejection of the ink, the ink is supplied from the reservoir 350. In addition, the ink is supplied to the reservoir 350 from the ink cartridge 31 through the ink inlet 370.

FIG. 4 is an explanatory diagram for describing an example of arrangement of M nozzles N provided in the recording head 30 when the ink jet printer 1 is seen in a plan view in a +Z direction or a −Z direction.

As illustrated in FIG. 4, four nozzle arrays Ln including a nozzle array Ln-BK formed of a plurality of nozzles N; a nozzle array Ln-CY formed of a plurality of nozzles N; a nozzle array Ln-MG formed of a plurality of nozzles N; and a nozzle array Ln-YL formed of a plurality of nozzles N are arranged on the recording head 30. In addition, each of the plurality of nozzles N belonging to the nozzle array Ln-BK is a nozzle N provided in the ejection unit D ejecting a black (BK) ink; each of the plurality of nozzles N belonging to the nozzle array Ln-CY is a nozzle N provided in the ejection unit D ejecting a cyan (CY) ink; each of the plurality of nozzles N belonging to the nozzle array Ln-MG is a nozzle N provided in the ejection unit D ejecting a magenta (MG) ink; and each of the plurality of nozzles N belonging to the nozzle array Ln-YL is a nozzle N provided in the ejection unit D ejecting a yellow (YL) ink. In addition, each of four nozzle arrays Ln are provided so as to extend in the +Y direction or the −Y direction (hereinafter, the +Y direction and −Y direction are collectively referred to as a “Y axis direction”) when seen in a plan view. Further, an area YNL in which each of the nozzle arrays Ln extends in the Y axis direction becomes equal to or wider than an area YP in the Y axis direction included in the recording paper P in a case where the recording paper P (accurately, in the recording paper P, the recording paper P whose width in the Y axis direction is the maximum in a level in which the ink jet printer 1 can perform printing) is printed.

As illustrated in FIG. 4, a plurality of nozzles N constituting each of the nozzle arrays Ln is arranged in a so-called zigzag shape such that the positions of the even-numbered nozzles N are differentiated from the positions of the odd-numbered nozzles N in the X axis direction from the left side (−Y side) in the figure. In each nozzle array Ln, the interval (pitch) between nozzles N in the Y axis direction can be suitably set according to the print resolution (dpi: dot per inch).

In addition, the printing process of the present embodiment is performed with the assumption that a plurality of images in one-to-one correspondence with a plurality of printing areas are formed after the recording paper P is divided into a plurality of printing areas (for example, an A4-size square area in a case of printing an A4-size image on the recording paper P or a label in label paper) and a margin area for dividing each of the plurality of printing areas as illustrated in FIG. 4, without forming one long image across the entire recording paper P.

### 3. Operation of Ejection Unit and Residual Vibration

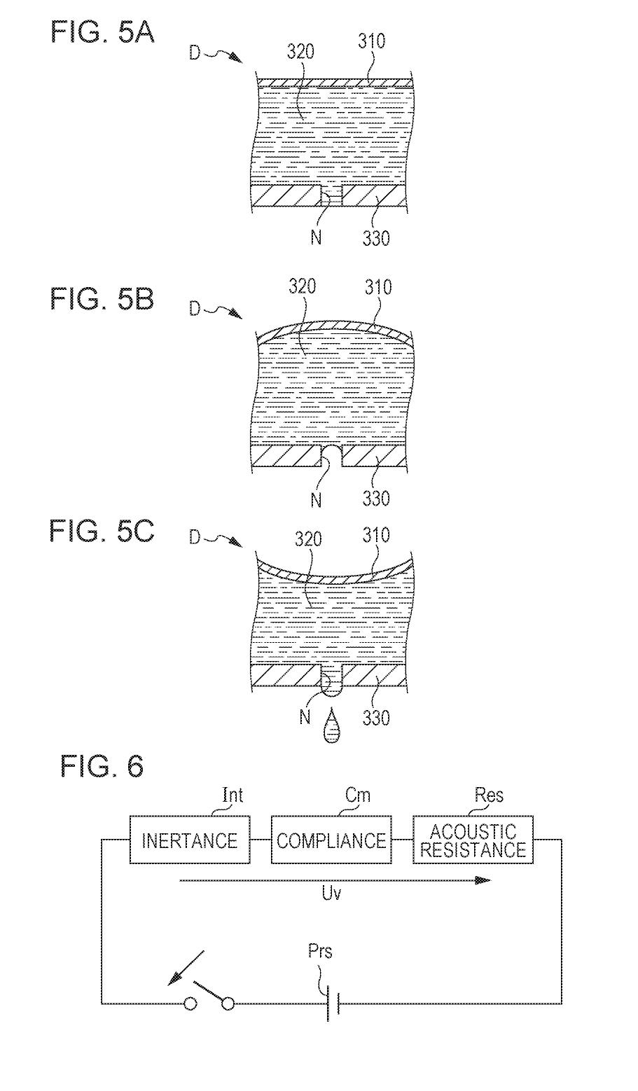

Next, an operation of ejecting an ink from the ejection unit D and the residual vibration generated in the ejection unit D will be described with reference to FIGS. 5A to 13.

FIGS. 5A to 5C are explanatory diagram for describing the operation of ejecting an ink from the ejection unit D.

When the driving signal Vin is supplied to the piezoelectric element 300 included in the ejection unit D from the head driver 50 in the state illustrated in FIG. 5A, distortion is generated in response to an electric field applied to a space between electrodes in the piezoelectric element 300, and the vibration plate 310 of the ejection unit D is deflected toward the upper direction in FIG. 5A. In this manner, the volume of the cavity 320 of the ejection unit D expands as illustrated in FIG. 5B compared to the initial state illustrated in FIG. 5A. In this state illustrated in FIG. 5B, when the potential indicated by the driving signal Vin is changed, the vibration plate 310 is restored by an elastic restoring force and shifted toward the lower direction in the figure over the position of the vibration plate 310 in the initial state, and the volume of the cavity 320 illustrated in FIG. 5C is rapidly contracted. At this time, some of the ink filling the cavity 320 is ejected as ink droplets from the nozzles N communicating with the cavity 320 by the compressed pressure generated in the cavity 320.

The vibration plate 310 of the respective ejection units D damping-vibrates, that is, residual-vibrates until the subsequent ink ejecting operation starts after a series of ink ejecting operations are finished. It is assumed that the residual vibration generated in the vibration plate 310 of the ejection unit D has a natural vibration frequency determined by shapes of the nozzles N and the ink supply port 360, or acoustic resistance Res due to ink viscosity, an inertance Int due to the ink weight within a flow path, and a compliance Cm of the vibration plate 310.

A calculation model of the residual vibration generated in the vibration plate 310 of the ejection unit D based on the assumption will be described.

FIG. 6 is a circuit diagram illustrating the calculation model of simple vibration which assumes the residual vibration of the vibration plate 310. As described above, the calculation model of the residual vibration of the vibration plate 310 is expressed by an acoustic pressure Prs, the above-described inertance Int, the compliance Cm, and the acoustic resistance Res. Further, if a step response is calculated for a volume velocity Uv when the acoustic pressure Prs is applied to the circuit of FIG. 6, the following equation is obtained.

Uv={Prs/(ω·Int)}e^{-σt}·sin(ωt)

ω={1/(Int·Cm)−α²}^{1/2}

σ=Res/(2·Int)

The calculation result (calculated value) obtained from the equation is compared with a test result (test value) in the test of the residual vibration of the ejection unit D, which is separately performed. In addition, the test of residual vibration is a test of detecting residual vibration generated in the vibration plate 310 of the ejection unit D after an ink is ejected from the ejection unit D whose ejection state of the ink is normal.

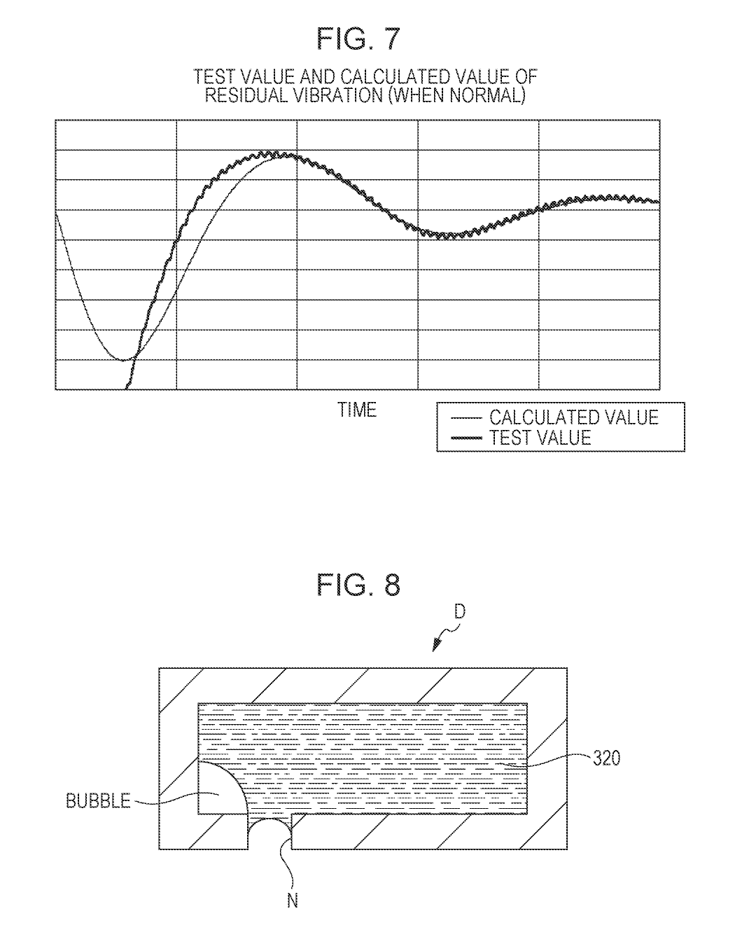

FIG. 7 is a graph illustrating a relation between test values and calculated values of the residual vibration. As understood from the graph of FIG. 7, two waveforms of the test values and the calculated values substantially coincide with each other in the case where the ejection state of the ink in the ejection unit D is normal.

There is a case in which the ejection state of the ink in the ejection unit D is abnormal and ink droplets are not normally ejected from the nozzle N of the ejection unit D, that is, ejection abnormality occurs even though the ink ejecting operation is performed by the ejection unit D. As a cause by which the ejection abnormality is generated, (1) mixing of bubbles into the cavity 320, (2) thickening or fixing of the ink in the cavity 320 caused by drying or the like of the ink in the cavity 320, or (3) adhering foreign substances such as paper powder to the vicinity of the outlet of the nozzle N can be exemplified.

As described above, the ejection abnormality typically means a state in which an ink cannot be ejected from the nozzle N, that is, a non-ejection phenomenon of the ink is exhibited. In this case, dot omission of a pixel in an image printed on the recording paper P occurs. Moreover, when the ejection abnormality occurs, even though the ink is ejected from the nozzle N, the ink cannot appropriately impact on the position because the amount of the ink is extremely small or a scattering direction (a trajectory) of the ejected ink droplets is shifted and thus dot omission occurs.

In the following description, based on the comparison result illustrated in FIG. 7, at least one value of the acoustic resistance Res and the inertance Int is adjusted so as to allow the calculated values and the test values of the residual vibration to substantially coincide with each other for each cause of the ejection abnormality occurring in the ejection unit D.

First, (1) the mixing of bubbles into the cavity 320 which is one cause of the ejection abnormality is inspected. FIG. 8 is a conceptual view for describing the case in which bubbles are mixed into the cavity 320. As illustrated in FIG. 8, in the case where bubbles are mixed into the cavity 320, it is considered that the total weight of the ink filling the cavity 320 is reduced and the inertance Int is decreased. Moreover, as illustrated in FIG. 8, in the case where a bubble is adhered to the vicinity of the nozzle N, it is considered that diameter of the nozzle N becomes larger by the diameter of the bubble and the acoustic resistance Res is decreased.

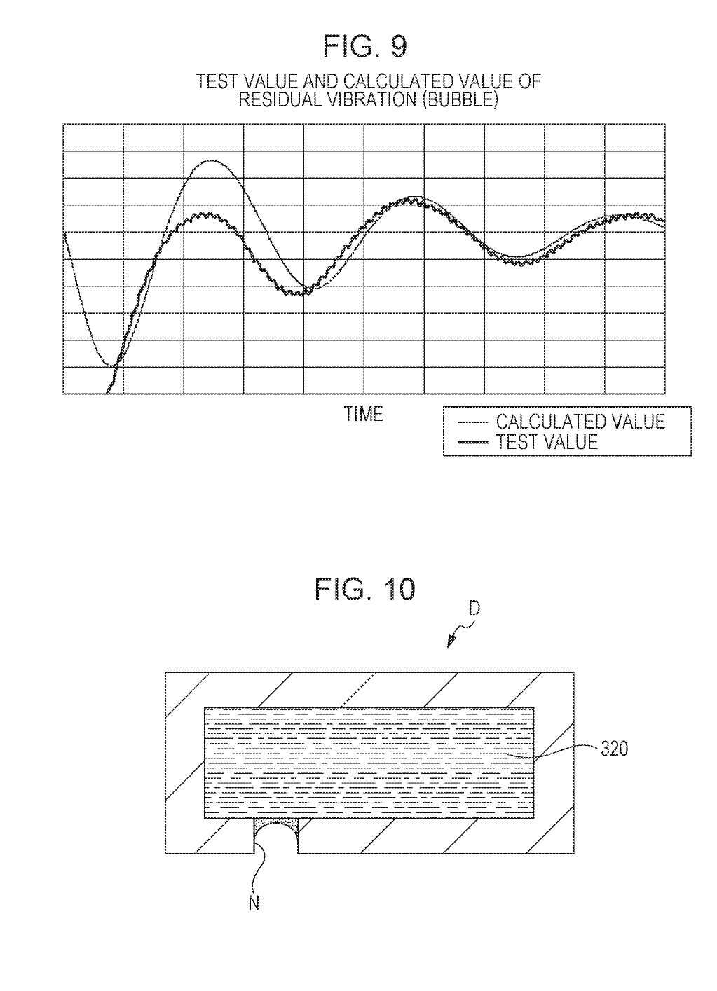

Accordingly, the acoustic resistance Res and the inertance Int are set to be small to match the test values of the residual vibration when bubbles are mixed in, compared to the case where the ejection state of the ink is normal as illustrated in FIG. 7, so that a result (a graph) illustrated in FIG. 9 is obtained. As can be seen from FIGS. 7 and 9, in the case where bubbles are mixed into the cavity 320 and thus the ejection abnormality occurs, the frequency of the residual vibration becomes higher compared to the case where the ejection state is normal. Further, it can be recognized that a damping rate of an amplitude of the residual vibration is also decreased due to a decrease in the acoustic resistance Res, so that the amplitude of the residual vibration is slowly decreased.

Next, (2) thickening or fixing of the ink in the cavity 320 which is another cause of the ejection abnormality is inspected. FIG. 10 is a conceptual view for describing the case in which an ink is fixed to the vicinity of the nozzle N of the cavity 320 due to drying. As illustrated in FIG. 10, when the ink in the vicinity of the nozzle N is dried and fixed, the ink in the cavity 320 is enclosed in the cavity 320. In such a case, it is considered that the acoustic resistance Res is increased.

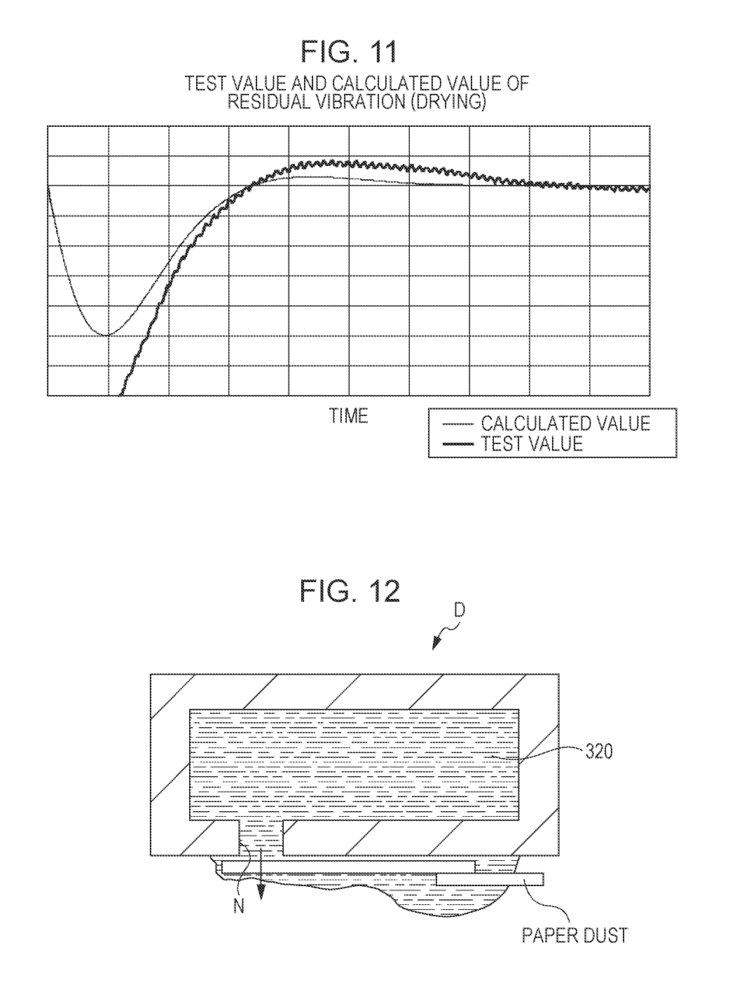

Accordingly, the acoustic resistance Res is set to be large to match the test values of the residual vibration when the ink in the vicinity of the nozzle N is fixed or thickened compared to the case where the ejection state of the ink is normal as illustrated in FIG. 7, so that a result (a graph) as in FIG. 11 is obtained. Further, the test values illustrated in FIG. 11 are obtained by measuring the residual vibration of the vibration plate 310 included in the ejection unit D in a state in which the ejection unit D stands still without mounting a cap (not illustrated) for several days and the ink in the vicinity of the nozzle N is fixed. As can be seen from FIGS. 7 and 11, when the ink is fixed to the vicinity of the nozzle N in the cavity 320, the frequency of the residual vibration is extremely decreased when compared to the case where the ejection state is normal, and a distinctive waveform in which the residual vibration is over-damped is obtained. This is because it is difficult for the vibration plate 310 to rapidly vibrate (due to the over-damping) since there is no retreat route of the ink in the cavity 320 at the time of the vibration plate 310 moving in the −Z direction (downwards) after the ink is allowed to flow into the cavity 320 from the reservoir by pulling the vibration plate 310 upwards in the +Z direction in order to eject the ink.

Next, (3) adhering of foreign substances such as paper dust to the vicinity of the outlet of the nozzle N which is one cause of the ejection abnormality is inspected. FIG. 12 is a conceptual view for describing the case where paper dust is adhered to the vicinity of the outlet of the nozzle N. As illustrated in FIG. 12, when the paper dust is adhered to the vicinity of the outlet of the nozzle N, the ink is exuded from the inside of the cavity 320 through the paper dust and the ink cannot be ejected from the nozzle N. In the case where paper dust is adhered to the vicinity of the outlet of the nozzle N and the ink is exuded from the nozzle N, since the exuded ink from the cavity 320 is more increased compared to the case where the ejection state is normal when viewed from the vibration plate 310, the inertance Int is increased. Moreover, it is considered that the acoustic resistance Res is increased by fibers of the paper dust adhered to the vicinity of the outlet of the nozzle N.

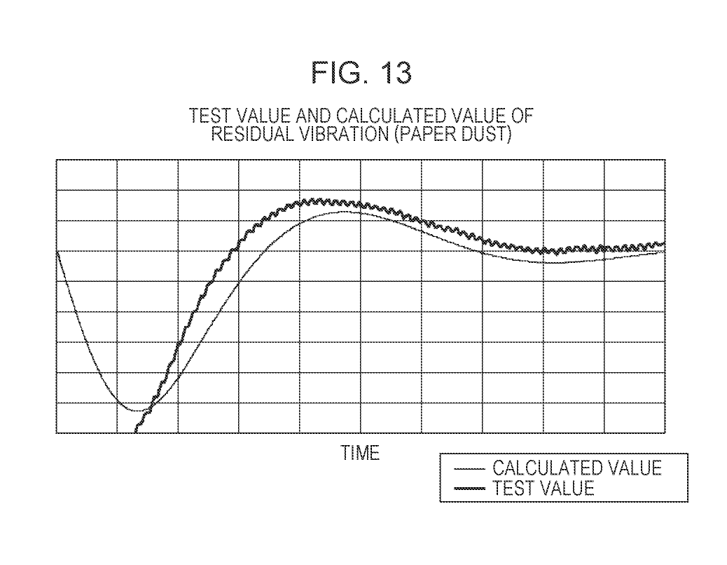

Accordingly, the inertance Int and the acoustic resistance Res are set to be large to match the test values of the residual vibration when the paper dust is adhered to the vicinity of the outlet of the nozzle N compared to the case where the ejection state of the ink is normal as illustrated in FIG. 7, so that a result (a graph) of FIG. 13 is obtained. As can be seen from the graphs of FIGS. 7 and 13, when foreign substances such as paper dust is adhered to the vicinity of the outlet of the nozzle N, the frequency of the residual vibration becomes lower compared to the case in which the ejection state is normal.

In addition, it is understood that the frequency of the residual vibration is high in the case where (3) foreign substances such as paper dust is adhered to the vicinity of the outlet of the nozzle N from the graphs of FIGS. 11 and 13 compared to the case where (2) the ink in the cavity 320 is thickened.

Here, in both cases of (2) thickening of an ink and (3) adhering paper dust to the vicinity of the outlet of the nozzle N, the frequency of the residual vibration is low compared to the case where the ejection state of the ink is normal. The two causes of the ejection abnormality can be distinguished from each other by comparing the waveform of the residual vibration, specifically, the frequency or the cycle of the residual vibration with a predetermined threshold value.

As is obvious from the above description, it is possible to determine the ejection state of the respective ejection units D based on the waveform, particularly, the frequency or the cycle of the residual vibration generated when the respective ejection units D are driven. More specifically, based on the frequency or the cycle of the residual vibration, it is possible to determine whether the ejection state in each of the ejection units D is normal and to determine to which numbers of (1) to (3) the cause of the ejection abnormality corresponds when the ejection state in each of the respective ejection units D is abnormal. The ink jet printer 1 according to the present embodiment performs the ejection state determining process of determining the ejection state by analyzing the residual vibration.

### 4. Configurations and Operations of Head Driver

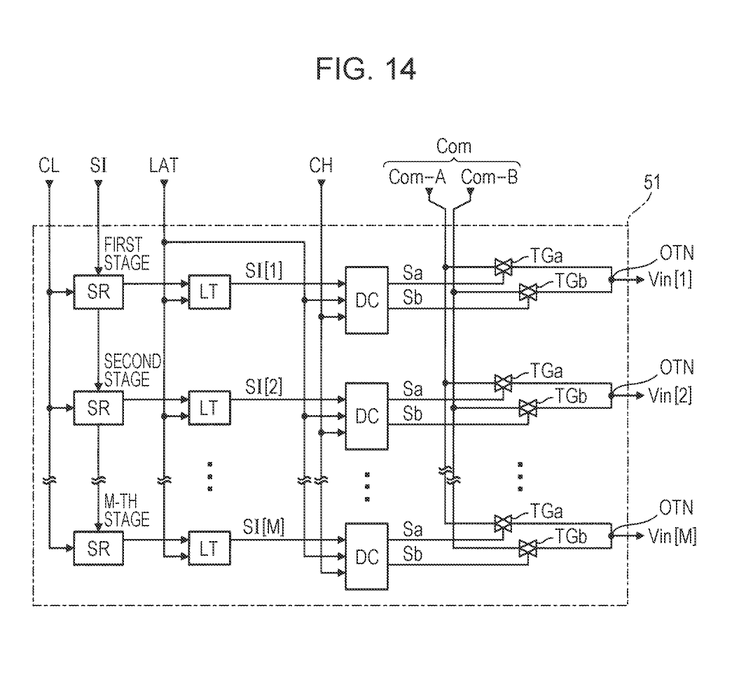

Next, the configurations and the operations of the head driver 50 (the driving signal generating unit 51, the residual vibration detecting unit 52, and the switching unit 53) and the ejection state determining unit 40 will be described with reference to FIGS. 14 to 21.

### 4.1. Driving Signal Generating Unit

FIG. 14 is a block diagram illustrating the configuration of the driving signal generating unit 51 of the head driver 50.

As illustrated in FIG. 14, the driving signal generating unit 51 has M sets including shift registers SR, latch circuits LT, decoders DC, and transmission gates TGa and TGb so as to be in one-to-one correspondence with the M ejection units D. In the following description, the respective elements constituting the M sets are referred to as a first stage, a second stage, . . . , and a M-th stage in order from the top in the drawing.

Clock signals CL, printing signals SI, latch signals LAT, change signals CH, and driving waveform signals Com (Com-A and Com-B) are supplied to the driving signal generating unit 51 from the control unit 6.

The driving waveform signals Com (Com-A and Com-B) include a plurality of waveforms for driving the ejection unit D.

The driving signal generating unit 51 selects waveforms to be supplied to respective ejection units D from the plurality of waveforms included in the driving waveform signals Com based on the print signal SI, generates a driving signal Vin having the selected waveforms, and supplies the generated driving signal Vin to the respective ejection units D.

Here, the print signal SI is a signal that designates waveforms to be supplied to the respective ejection units D from the plurality of waveforms included in the driving waveform signals Com. Specifically, the print signal SI is a digital signal that designates the waveforms of the driving waveform signals Com to be supplied to the respective ejection units by 2 bits of a high-order bit b1 and a low-order bit b2 and are serially supplied to the driving signal generating unit 51 in synchronization with the clock signals CL from the control unit 6.

Hereinafter, in the print signals SI, a signal of 2 bits designating the waveforms of the driving waveform signals to be supplied to the ejection unit D[m] is referred to as a print signal SI[m]. Further, hereinafter, in the driving signals Vin, a driving signal Vin which is generated based on designation of the print signal SI[m] and supplied to the ejection unit D[m] is referred to as a driving signal Vin[m].

That is, the driving signal generating unit 51 selects a waveform to be supplied to the ejection unit D[m] based on the designation of the print signal SI[m], from among the plurality of waveforms included in the driving waveform signals COM, generates a driving signal Vin[m] based on the selected waveform, and supplies the generated driving signal Vin[m] to the ejection unit D[m].

As described above, the ejection unit D[m] is driven by the driving signal Vin[m]. In addition, the waveform of the driving signal Vin[m] is a waveform selected from the waveforms included in the driving waveform signals Com based on the designation of the print signal SI[m]. That is, the presence of ejection of an ink from the ejection unit D[m], the amount of the ink to be ejected by the ejection unit D[m], and the driving mode of the ejection unit D[m] are regulated by the print signal SI[m].

Specifically, in a case where the ink jet printer 1 performs the printing process, the printing signal SI[m] regulates the amount of ink ejected from the ejection unit D[m] at the time when the ejection unit D[m] forms one dot of an image. By controlling the amount of ink ejected from the ejection unit D[m] by the printing signal SI[m], it is possible to express four gradation steps of non-recording, a small dot, a medium dot and a large dot in the respective dots of the recording paper P.

Further, in a case where the ink jet printer 1 performs the ejection state determining process, the print signal SI designates a waveform as a waveform of the driving signal Vin[m] to be supplied to the ejection unit D[m] which is a target of the ejection state determining process such that residual vibration which enables the ejection state of the ink in the ejection unit D[m] to be determined is generated.

The shift registers SR temporarily hold the serially supplied printing signals SI (SI[1] to SI[M]) for every 2 bits corresponding to the respective ejection units D. Specifically, the M shift registers SR of the first stage, the second stage, . . . , and the M-th stage in one-to-one correspondence with the M ejection units D are cascade-connected to each other, and the printing signals SI serially supplied are sequentially transferred to the subsequent stage in response to the clock signals CL. Furthermore, when the printing signals SI are transferred to all of the M shift registers SR, each of the M shift registers SR maintains a state where each of the M shift registers holds data of 2 bits corresponding to each shift register among the printing signals SI. Hereinafter, the shift resistor SR of the m-th stage is referred to as a shift resistor SR[m] in some cases.

Each of the M latch circuits LT simultaneously latches the printing signals SI[m] of 2 bits corresponding to the respective stages held by the respective M shift registers SR at the timing when the latch signals LAT rise. That is, the latch circuit LT of the m-th stage latches the print signal SI[m] held by the shift resistor SR[m].

On the other hand, the operation period which is a period for which the ink jet printer 1 operates at least one process among the printing process and the ejection state determining process is formed of a plurality of unit operation periods Tu.

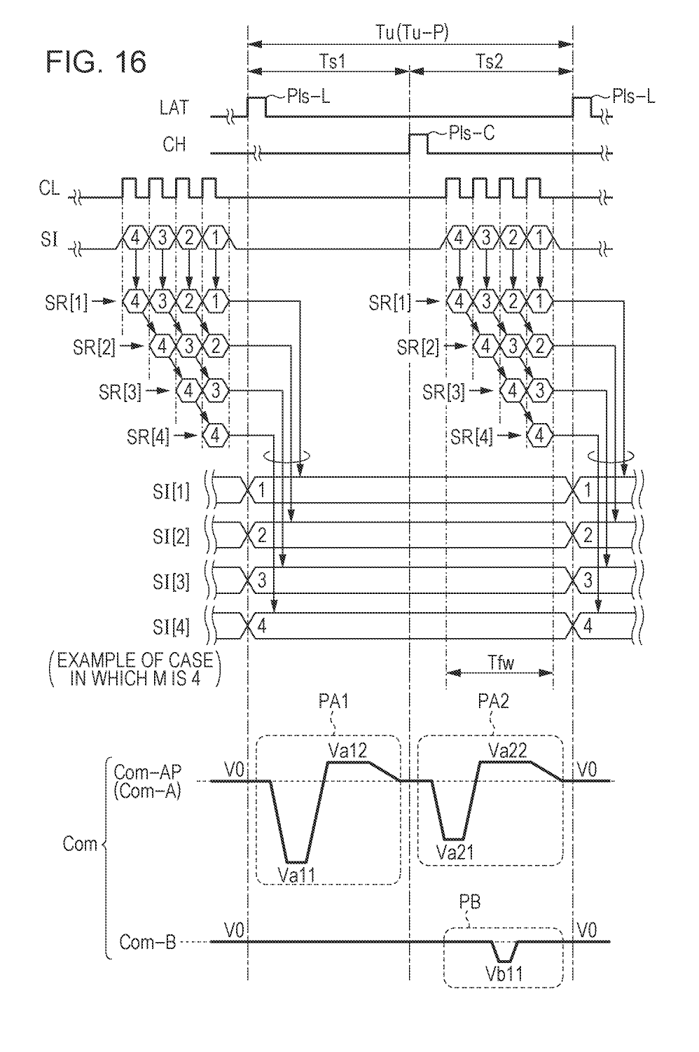

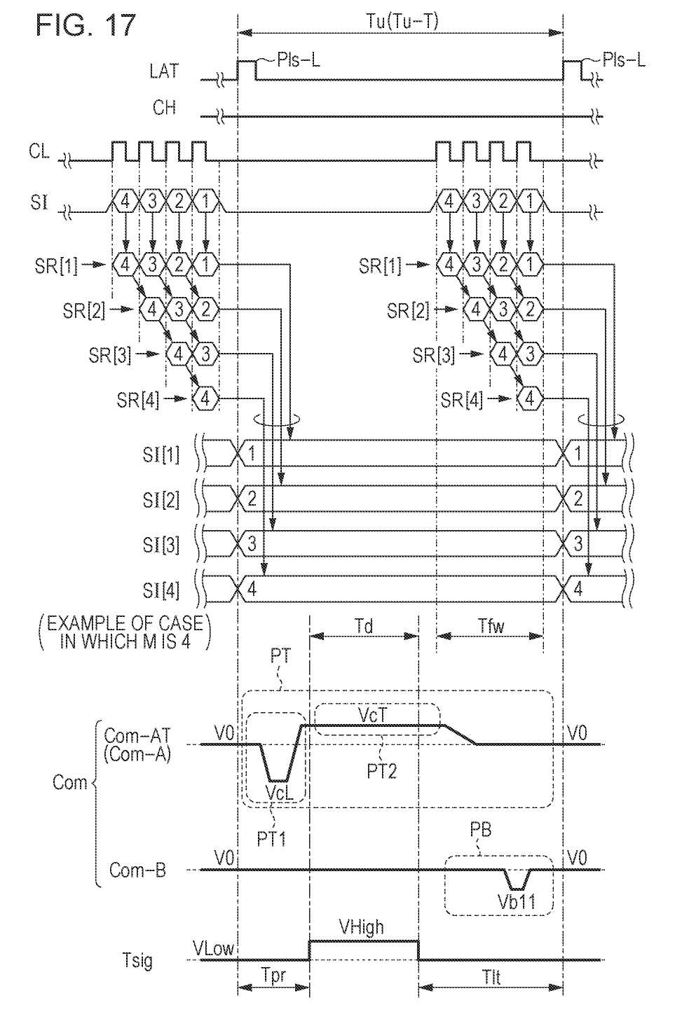

In addition, in the present embodiment, the unit periods Tu are classified into two unit operation periods Tu, which are a unit print operation period Tu-P (see FIG. 16) which is a unit period Tu for which the printing process is performed and a unit determination operation period Tu-T (see FIG. 17) which is a unit period Tu for which the ejection state determination process is performed.

As described above, the ink jet printer 1 according to the present embodiment divides the long recording paper P into a plurality of printing areas and a margin area for dividing each of the plurality of printing areas and then forms one image with respective to the respective printing areas.

Specifically, the control unit 6 classifies the period, for which at least a part of the printing area of the recording paper P is positioned on the lower side (−Z side) of the recording head 30, in the plurality of unit periods Tu constituting the operation period into the unit print operation period Tu-P and controls operations of the respective units of the ink jet printer 1 such that the printing process is performed during the unit print operation period Tu-P.

Meanwhile, the control unit 6 classifies the period for which only the margin area of the recording paper P is positioned on the lower side (−Z side) of the recording head 30 into the unit determination operation period Tu-T, in the plurality of unit operation periods Tu constituting the operation period and controls operations of the respective units of the ink jet printer 1 such that the ejection state determining process is performed during the unit determination operation period Tu-T.

The control unit 6 supplies the printing signals SI to the driving signal generating unit 51 for each unit period Tu (the unit print operation period Tu-P and the unit determination operation period Tu-T) and supplies the latch signals LAT such that the latch circuits LT latch the printing signals SI[1], SI[2], . . . , SI[M] for each unit period Tu. That is, the control unit 6 controls the driving signal generating unit 51 such that the driving signals Vin are supplied to the M ejection units D for each unit period Tu.

More specifically, the control unit 6 controls the driving signal generating unit 51 such that the driving signals Vin for a printing process, which is used for performing the printing process of ejecting an ink having an amount according to the print data Img onto the recording paper P and forming an image corresponding to the print data Img on the recording paper P, are supplied to the respective ejection units D[m] during the unit print operation period Tu-P, for which the printing process is performed, in the plurality of unit periods Tu.

Further, the control unit 6 controls the driving signal generating unit 51 such that the driving signals Vin for an ejection state determining process, which is used for performing the ejection state determining process of determining whether ejection abnormality occurs in the ejection unit D[m], are supplied to the ejection unit D[m] which is a target of the ejection state determining process during the unit determination operation period Tu-T, for which the ejection state determining process is performed, in the plurality of unit periods Tu.

Moreover, in the present embodiment, the control unit 6 divides the unit print operation period Tu-P in the unit period Tu into a control period Ts1 and a control period Ts2 described below using a change signal CH. The control periods Ts1 and Ts2 have the same time length.

The decoder DC decodes the printing signal SI[m] of 2 bits latched by the latch circuit LT and outputs selection signals Sa and Sb.

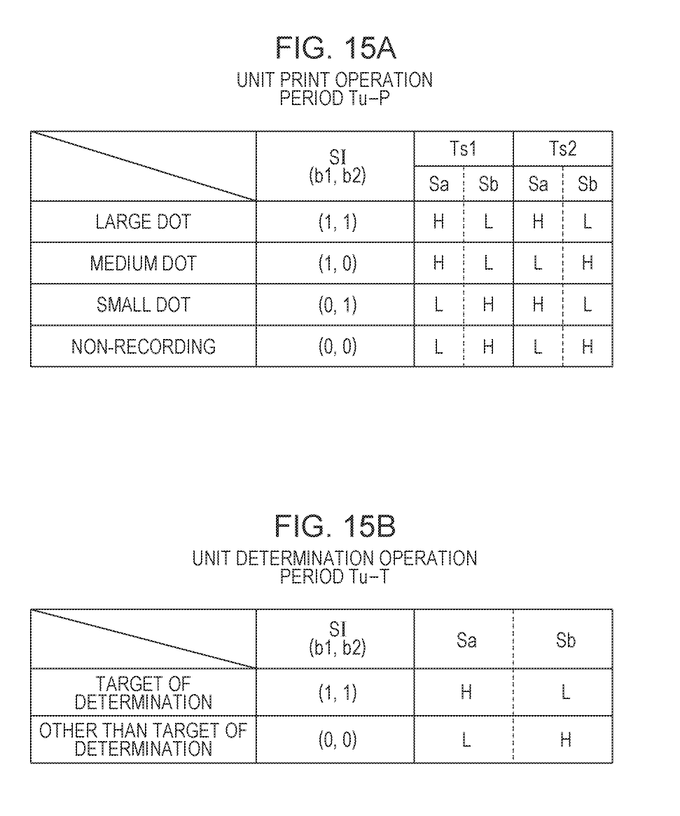

FIGS. 15A and 15B are explanatory diagrams illustrating contents of decoding performed by the decoder DC during each unit period Tu. Among these, FIG. 15A illustrates contents of decoding performed by the decoder DC during the unit print operation period Tu-P for which the printing process is performed and FIG. 15B illustrates contents of decoding performed by the decoder DC during the unit determination operation period Tu-T for which the ejection state determining process is performed.

As illustrated in FIG. 15A, each decoder DC outputs selection signals Sa and Sb during each of the control periods Ts1 and Ts2 in the unit print operation period Tu-P. For example, in a case where the contents shown by the print signal SI[m] indicates “(b1, b2)=(1.0)” during the unit print operation period Tu-P, the decoder DC of the m-th stage sets the selection signal Sa at a high level H and sets the selection signal Sb at a low level L during the control period Ts1 and sets the selection signal Sb at a high level H and sets the selection signal Sa at a low level L during the control period Ts2.

As illustrated in FIG. 15B, each decoder DC outputs individual selection signals Sa and Sb during each unit period Tu in the unit determination operation period Tu-T. For example, in a case where the contents shown by the print signal SI[m] indicates “(b1, b2)=(1.1)” during the unit period Tu, the decoder DC of the m-th stage maintains the selection signal Sa at a high level H and sets the selection signal Sb at a low level L during the unit period Tu.

As illustrated in FIG. 14, the driving signal generating unit 51 includes M sets of transmission gates TGa and TGb. The M sets of transmission gates TGa and TGb are provided in one-to-one correspondence with the M ejection units D. The transmission gate TGa is turned on when the selection signal Sa is in a high level H and is turned off when the selection signal Sa is in a low level L. The transmission gate TGb is turned on when the selection signal Sb is in a high level H, and is turned off when the selection signal Sb is in a low level L.

For example, in the unit print operation period Tu-P, when the content indicated by the printing signal Si[m] indicates “(b1, b2)=(1, 0),” the transmission gate TGa is turned on and the transmission gate TGb is turned off during the control period Ts1, and the transmission gate TGb is turned on and the transmission gate TGa is turned off during the control period Ts2.

As illustrated in FIG. 14, the driving waveform signal Com-A is supplied to one terminal of the transmission gate TGa and the driving waveform signal Com-B is supplied to one terminal of the transmission gate TGb. Moreover, the other terminals of the transmission gates TGa and TGb are commonly connected to an output terminal OTN to the switching unit 53.

As evident from FIGS. 15A and 15B, the transmission gates TGa and TGb are controlled to be exclusively turned on. Accordingly, the transmission gates TGa and TGb of the m-th stage output one of the driving waveform signals Com-A and Com-B to the output terminal OTN of the m-th stage at each timing of the operation periods. That is, the driving signal generating unit 51 selects the driving waveform signal Com-A or Com-B by controlling ON and OFF of the transmission gates TGa and TGb of the m-th stage using the selection signals Sa and Sb generated based on the print signal SI[m] and supplies the selected driving waveform signal Com to the ejection unit D[m] as the driving signal Vin[m].

### 4.2. Driving Waveform Signal

FIGS. 16 and 17 are timing charts for describing various signals supplied to the driving signal generating unit 51 by the control unit 6 during the respective unit periods Tu and the operation of the driving signal generating unit 51 during respective unit periods Tu.

FIG. 16 illustrates an example of the signal to be supplied to the driving signal generating unit 51 and the operation of the driving signal generating unit 51 during the unit print operation period Tu-P for which the printing process is performed and FIG. 17 illustrates an example of the signal to be supplied to the driving signal generating unit 51 and the operation of the driving signal generating unit 51 during the unit determination operation period Tu-T for which the ejection state determining process is performed.

As illustrated in FIGS. 16 and 17, the latch signal LAT output by the control unit 6 includes a pulse Pls-L for regulating the unit periods Tu.

Further, as illustrated in FIG. 16, the change signal CH output by the control unit 6 includes a pulse Pls-C for distinguishing the control period Ts1 from the control period Ts2 during the unit print operation period Tu-P.

As illustrated in FIGS. 16 and 17, the control unit 6 supplies the print signals SI to the driving signal generating unit 51 in synchronization with the clock signal CL during a print signal transfer period Tfw in respective unit periods Tu. In addition, the transistor SR sequentially transfers the print signals SI[m] supplied from the control unit 6 to the subsequent state during the print signal transfer period Tfw according to the clock signal CL.

More specifically, as illustrated in FIGS. 16 and 17, the control unit 6 supplies the print signals SI to the shift resistor SR[1] in order of Si[M], SI[M−1], . . . , SI[2], SI[1] for each cycle of the clock signal CL during the print signal transfer period Tfw. Further, the print signals SI[m] supplied to the shift resistor SR[1] are transferred in order of the shift resistor SR[1], SI[2], . . . , SI[m] for each cycle of the clock signal CL. For this reason, the shift resistors SR[1] to SR[M] hold print signals SI[1] to SI[M] when the print signal transfer period Tfw for which the supply of the print signals SI (SI[1] to SI[M]) to be supplied to the driving signal generating unit 51 by the control unit 6 during the unit period Tu is completed is finished. The shift resistors SR[1] to SR[M] hold the print signals SI[1] to SI[M]. Subsequently, the latch circuit LT latches the print signals SI[1] to SI[M] held by the shift transistors SR[1] to SR[M] at the timing at which the pulse Pls-L is supplied as the latch signal LAT.

Meanwhile, the control unit 6 does not supply the print signal SI and the clock signal CL to the driving signal generating unit 51 during the period other than the print signal transfer period Tfw in the unit period Tu.

Further, in FIGS. 16 and 17, for convenience of illustration, a case where M is 4 is exemplified.

As illustrated in FIGS. 16 and 17, in the present embodiment, a waveform of the driving waveform signal Com-A output by the control unit 6 varies in the unit print operation period Tu-P and the unit determination operation period Tu-T. The control unit 6 selects a waveform of the driving waveform signal Com-A by referring to a set parameter (not illustrated) stored in the storage unit 60.

Hereinafter, a signal output by the control unit 6 during the unit print operation period Tu-P from among the driving waveform signals Com-A is referred to as a driving waveform signal Com-AP for printing (see FIG. 16). In addition, a signal output by the control unit 6 during the unit determination operation period Tu-T from among the driving waveform signals Com-A is referred to as a driving waveform signal Com-AT for determination (see FIG. 17).

As illustrated in FIG. 16, the driving waveform signal Com-AP for printing which is output by the control unit 6 during the unit print operation period Tu-P is a signal having a waveform PA1 provided during the control period Ts1 and a waveform PA2 provided during the control period Ts2.

The waveform PA1 is a waveform in which the medium amount of ink corresponding to a medium dot is ejected from the ejection unit D when a signal of the waveform PA1 is supplied to the ejection unit D as the driving signal Vin.

The waveform PA2 is a waveform in which the small amount of ink corresponding to a small dot is ejected from the ejection unit D when a signal of the waveform PA2 is supplied to the ejection unit D as the driving signal Vin.

For example, a potential difference between the minimum potential Va11 and the maximum potential Va12 of the waveform PA1 is determined so as to be larger than a potential difference between the minimum potential Va21 and the maximum potential Va22 of the waveform PA2.

As illustrated in FIGS. 16 and 17, the driving waveform signal Com-B output by the control unit 6 during the unit periods Tu (the unit print operation period Tu-P and the unit determination operation period Tu-T) is a signal having a waveform PB (an example of a “microvibration waveform”). The waveform PB is a waveform in which an ink is not ejected from the ejection unit D even in a case where a signal of the waveform PB is supplied to the ejection unit D as the driving signal Vin. That is, the waveform PB is a waveform for preventing the ink from being thickened by applying microvibration to the ink in the inside of the ejection unit D. For example, a potential difference between the minimum potential Vb11 and the maximum potential of the waveform PB (reference potential V0 in the figure) is determined so as to be smaller than a potential difference between the minimum potential Va21 and the maximum potential Va22 of the waveform PA2.

As illustrated in FIG. 17, the driving waveform signal Com-AT for determination which is output by the control unit 6 is a signal having waveforms PT during the unit determination operation period Tu-T.

In the present embodiment, the waveforms PT includes a waveform PT1 that drives the ejection unit D[m] such that residual vibration is generated in the ejection unit D[m] and a waveform PT2 for maintaining the residual vibration generated in the ejection unit D[m] after the ejection unit D[m] is driven by the driving signal Vin[m] having the waveform PT1.

The waveform PT1 is a waveform in which an ink is not ejected from the ejection unit D[m] in a case where the driving signal Vin[m] having the waveform PT1 is supplied to the ejection unit D[m]. For example, a potential difference between the minimum potential VcL of the waveform PT1 and the detection potential VcT which is the maximum potential is of the wave form PT1 determined to be smaller than a potential difference between the minimum potential Va21 and the maximum potential Va22 of the waveform PA2. That is, the ejection state determining process according to the present embodiment assumes so-called “non-ejection inspection” in which the ejection state of the ink in the ejection unit D is determined based on the residual vibration generated in the ejection unit D when the ejection unit D is driven such that the ink is not ejected.

In this case, the waveform PT1 may be a waveform in which an ink is ejected from the ejection unit D[m] in a case where the driving signal Vin[m] having the waveform PT1 is supplied to the ejection unit D[m]. That is, the ejection state determining process may be performed as “ejection inspection.”

The waveform PT2 is a flat waveform supported by the detection potential VcT. It is possible to prevent superimposition of vibration caused by the driving signal Vin[m] as noise with respect to residual vibration by supplying the waveform PT2 after the residual vibration is generated in the ejection unit D[m] and to accurately detect residual vibration generated by the waveform PT1.

The residual vibration detecting unit 52 detects the residual vibration generated in the ejection unit D[m] as the residual vibration signal Vout during the detection period Td which is a part of the period for which a signal of the waveform PT2 is supplied as the driving waveform signal Com-AT for determination. In addition, in the present embodiment, the detection period Td is regulated as a period for which a detection period designation signal Tsig is a predetermined detection period designation potential VHigh.

Moreover, as illustrated in FIGS. 16 and 17, a period from when the detection period Td is finished to when the unit period Tu is finished in the unit periods Tu is referred to as a period Tlt after detection (an example of the “first period”) and a period from when the unit period Tu is started to when the detection period Td is started in the unit periods Tu is referred to as a period Tpr before detection (an example of the “second period”).

As illustrated in the figures, the print signal transfer period Tfw according to the present embodiment is provided so as to be included in the period Tlt after detection. In other words, the control unit 6 supplies the print signals SI, after the print signal transfer period Tfw is finished, to the driving signal generating unit 51 during the respective unit determination operation periods Tu-T.

In addition, in the present embodiment, the waveform PB is provided in the period Tlt after detection.

4.3. Driving signal

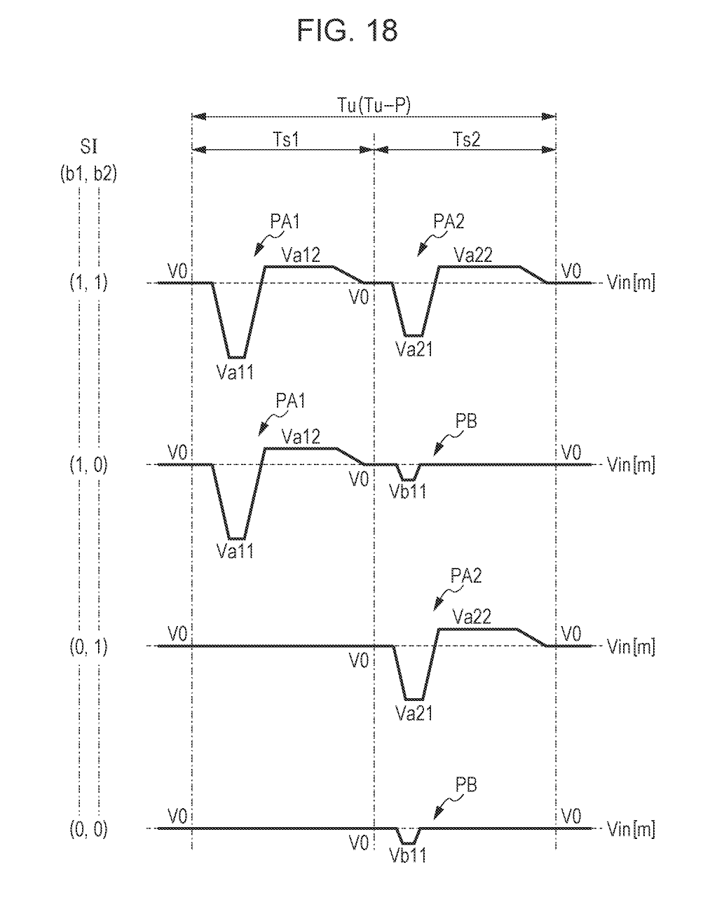

Next, the driving signal Vin output by the driving signal generating unit 51 during the unit operation period Tu will be described with reference to FIG. 18.

In a case where the printing signal SI[m] supplied during the unit print operation period Tu-P indicates “(b1, b2)=(1, 1),” the selection signals Sa is in a high level H during the control period Ts1, the driving waveform signal Com-A is selected by turning the transmission gate TGa ON, and the waveform PA1 is output as the driving signal Vin[m]. Similarly, during the control period Ts2, the driving waveform signal Com-A is selected and the waveform PA2 is output as the driving signal Vin[m]. Accordingly, in the case where the print signal SI[m] indicates “(b1, b2)=(1, 1),” the driving signals Vin[m] supplied to the ejection unit D during the unit print operation period Tu-P includes the waveform PA1 and the waveform PA2. As a result, the ejection unit D[m] performs ejection of the medium amount of ink based on the unit waveform PA1 and ejection of the small amount of ink based on the unit waveform PA2, and the inks ejected twice are united, so that a large dot is formed on the recording paper P.

When the printing signal SI[m] supplied during the unit print operation period Tu-P indicates “(b1, b2)=(1, 0),” since the driving waveform signal Com-A is selected during the control period Ts1 and the driving waveform signal Com-B is selected during the control period Ts2, the driving signals Vin[m] supplied to the ejection unit D[m] include the waveform PA1 and the waveform PB. As a result, the ejection unit D[m] performs ejection of the medium amount of ink based on the unit waveform PA1 so that a medium dot is formed on the recording paper P.

When the printing signal SI[m] supplied during the unit print operation period Tu-P indicates “(b1, b2)=(0, 1),” since the driving waveform signal Com-B is selected during the control period Ts1 and the driving waveform signal Com-A is selected during the control period Ts2, the driving signals Vin[m] supplied to the ejection unit D[m] include the waveform PA2. As a result, the ejection unit D[m] performs ejection of the small amount of ink based on the unit waveform PA2 so that a medium dot is formed on the recording paper P.

When the printing signal SI[m] supplied during the unit print operation period Tu-P indicates “(b1, b2)=(0, 0),” the driving waveform signal Com-B is selected during the control periods Ts1 and Ts2, and the driving signal Vin[m] for a print process which is supplied to the ejection unit D[m] includes the waveform PB. As a result, the ejection unit D[m] does not eject an ink and a dot is not formed on the recording paper P (becomes non-recording).

Meanwhile, the print signal SI[m] output by the control unit 6 during the unit determination operation period Tu-T is “(b1, b2)=(1, 1)” or “(b1, b2)=(0, 0).” More specifically, the control unit 6 sets the print signal SI[m] as (1, 1) in a case where the ejection unit D[m] is used as a target of the ejection state determination process during the unit determination operation period Tu-T and sets the print signal SI[m] as (0, 0) in a case where the ejection unit D[m] is not used as a target of the ejection state determination process during the unit determination operation period Tu-T.

Accordingly, the driving signal Vin[m] to be supplied to the ejection unit D[m] during the unit determination operation period Tu-T becomes a driving waveform signal Com-AT for determination in a case where the ejection unit D[m] is used as a target of the ejection state determining process during the unit determination operation period Tu-T and the driving signal Vin[m] to be supplied to the ejection unit D[m] during the unit determination operation period Tu-T becomes a driving waveform signal Com-B in a case where the ejection unit D[m] is not used as a target of the ejection state determining process during the unit determination operation period Tu-T.

### 4.4. Switching Unit and Residual Vibration Detecting Unit

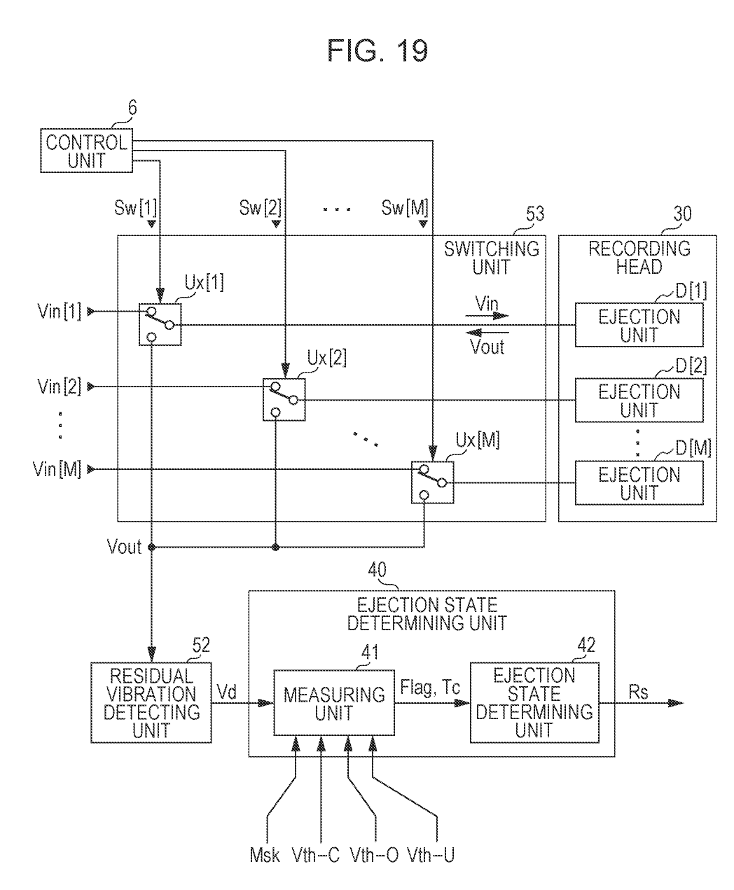

FIG. 19 is a block diagram illustrating an example of a configuration of the switching unit 53 and the residual vibration detecting unit 52 provided in the head driver 50, and a configuration of the ejection state determining unit 40.

As illustrated in FIG. 19, the switching unit 53 includes M switching circuits Ux (Ux[1], Ux[2], . . . , and Ux[M]) having first to M-th stages in one-to-one correspondence with the M ejection units D.

The switching circuit Ux[m] of the m-th stage electrically connects the upper electrode 302 of the piezoelectric elements 300 of the ejection unit D[m] to any one of an output terminal OTN of the m-th stage included in the driving signal generating unit 51 and the ejection abnormality detecting unit 52.

In the following description, a state where the switching circuit Ux[m] electrically connects the ejection unit D[m] and the output terminal OTN of the m-th stage of the driving signal generating unit 51 is referred to as a first connection state. Moreover, a state where the switching circuit Ux[m] electrically connects the ejection unit D[m] and the residual vibration detecting unit 52 is referred to as a second connection state.

The control unit 6 outputs the switching control signals Sw for controlling the connection states of the respective switching circuits Ux to the respective switching circuits U.

Specifically, in the unit print operation period Tu-P for which the printing process is performed, the control unit 6 supplies the switching control signal Sw[m] to the switching circuit Ux[m] so as to allow the switching circuit Ux[m] to maintain the first connection state over the entire period of the unit print operation period Tu-P. For this reason, the control unit 6 supplies the driving signal Vin[m] to the ejection unit D[m] from the driving signal generating unit 51 over the entire period of the unit print operation period Tu-P.

Further, when the ejection unit D[m] is a target of the ejection state determining process during the unit determination operation period Tu-T for which the ejection state determination process is performed, the control unit 6 supplies the switching control signal Sw[m] to the switching circuit Ux[m] so as to allow the switching circuit Ux[m] to enter the first connection state during a period other than the detection period Td in the unit determination operation period Tu-T and to enter the second connection state during the detection period Td in the unit determination operation period Tu-T.

For this reason, in a case where the ejection unit D[m] becomes a target of the ejection state determining process during the unit determination operation period Tu-T, the driving signal Vin[m] is supplied to the ejection unit D[m] from the driving signal generating unit 51 during the period other than the switching period Td in the unit determination operation period Tu-T, and the residual vibration signal Vout is supplied to the residual vibration detection unit 52 from the ejection unit D[m] during the detection period Td in the unit determination operation period Tu-T.

In addition, the control unit 6 supplies the switching control signal Sw[m] to the switching circuit Ux[m] so as to allow the switching circuit Ux[m] to maintain the first connection state over the entire period of the unit determination operation period Tu-T in a case where the ejection unit D[m] is not a target of the ejection state determining process during the unit determination operation period Tu-T.

For this reason, in the case where the ejection unit D[m] is not a target of the ejection state determining process during the unit determination operation period Tu-T, the driving signal Vin[m] is supplied to the ejection unit D[m] from the driving signal generating unit 51 over the entire period of the unit determination operation period Tu-T.

Further, in the present embodiment, as illustrated in FIG. 19, a case where the ink jet printer 1 includes only one residual vibration detecting unit 52 with respect to M ejection units D and each of the residual vibration detecting units 52 can detect only residual vibration generated in one ejection unit D during one unit period Tu is assumed. That is, the control unit 6 according to the present embodiment selects one ejection unit D from among the M ejection units D as a target of the ejection state determining process during one unit determination operation period Tu-T and controls respective units of the ink jet printer 1 such that the ejection state of the ink in the selected ejection unit D is determined.

Therefore, the control unit 6 generates the switching control signal Sw such that the ejection unit D selected as a target of the ejection state determining process during respective unit determination operation periods Tu-T is electrically connected to the residual vibration detecting unit 52 in the second connection state during the detection period Td in the unit determination operation period Tu-T.

The residual vibration detecting unit 52 illustrated in FIG. 19 generates a waveform shaping signal Vd based on the residual vibration signal Vout as described above. Here, the waveform shaping signal Vd is a signal of removing a noise component from the residual vibration signal Vout and adjusting the amplitude of the residual vibration signal Vout from which the noise component is removed to an amplitude suitable for the process of the ejection state determining unit 40.

The residual vibration detecting unit 52 includes a high-pass filter and a low-pass filter and has a configuration capable of outputting the waveform shaping signal Vd from which the noise component is removed by limiting a frequency range of the residual vibration signal Vout. Moreover, the residual vibration detecting unit 52 may include a negative feedback type amplifier for adjusting the amplitude of the residual vibration signal Vout and a voltage follower for converting an impedance of the residual vibration signal Vout to output the waveform shaping signal Vd of a low impedance.

### 4.5 Ejection State Determination Unit

The ejection state determining unit 40 illustrated in FIG. 19 determines the ejection state of an ink in the ejection unit D based on the waveform shaping signal Vd output by the residual vibration detecting unit 52 and generates determination information RS showing the determination results.

The ejection state determining unit 40 includes a measuring unit 41 and a determination information generating unit 42 as illustrated in FIG. 19. The measuring unit 41 measures a time length of residual vibration for one cycle which is generated in the ejection unit D based on the waveform shaping signal Vd output by the residual vibration detecting unit 52 and generates a measurement signal Tc showing the measurement results. In addition, the measuring unit 41 generates an effective flag Flag indicating whether the generated measurement signal Tc is an effective value. The determination information generating unit 42 outputs the determination information RS showing determination results of the ejection state of the ink in the ejection unit D based on the measurement signal Tc output by the measuring unit 41 and the effective flag Flag.

As illustrated in FIG. 19, the waveform shaping signal Vd output by the residual vibration detecting unit 52, a mask signal Msk generated by the control unit 6, a threshold potential Vth_C determined as a potential of an amplitude center level of the waveform shaping signal Vd, a threshold potential Vth_O determined as a potential higher than the threshold potential Vth_C, and a threshold potential Vth_U determined as a potential lower than the threshold potential Vth_C are supplied to the measuring unit 41.

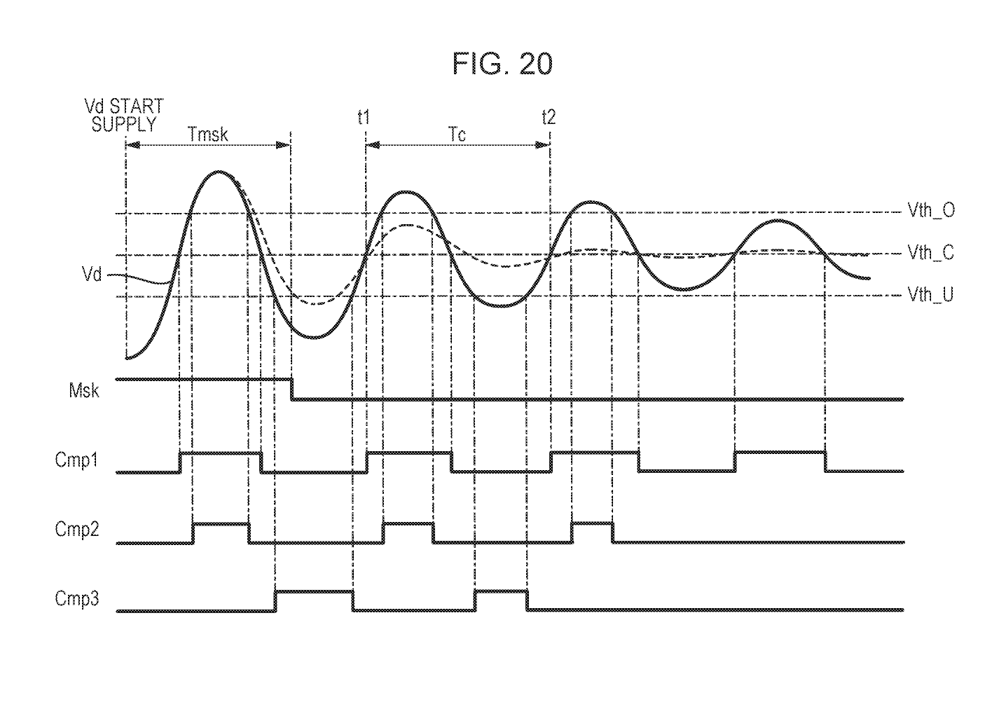

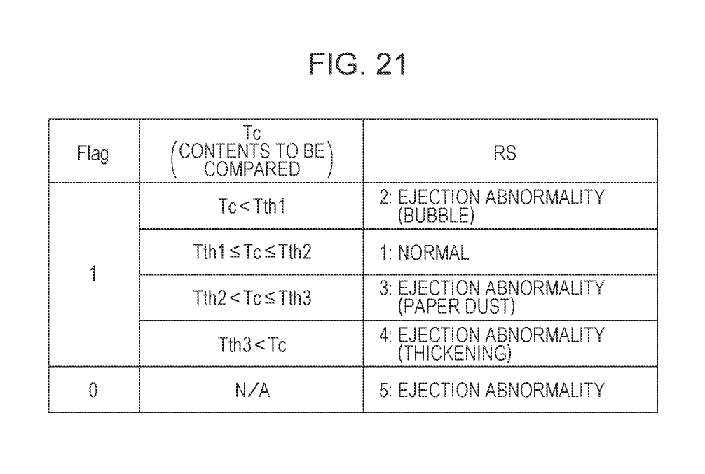

FIG. 20 is a timing chart illustrating an operation of the measuring unit 41.

As illustrated in the figure, the measuring unit 41 compares a potential indicated by the waveform shaping signal Vd with the threshold potential Vth_C, and generates a comparison signal Cmp1 which is in a high level when the potential indicated by the waveform shaping signal Vd is equal to or greater than the threshold potential Vth_C and is in a low level when the potential indicated by the waveform shaping signal Vd is less than the threshold potential Vth-C. Moreover, the measuring unit 41 compares the potential indicated by the waveform shaping signal Vd with the threshold potential Vth_O, and generates a comparison signal Cmp2 which is in a high level when the potential indicated by the waveform shaping signal Vd is equal to or greater than the threshold potential Vth_O and is in a low level when the potential indicated by the waveform shaping signal Vd is less than the threshold potential Vth_O. Moreover, the measuring unit 41 compares the potential indicated by the waveform shaping signal Vd with the threshold potential Vth_U, and generates a comparison signal Cmp3 which is in a high level when the potential indicated by the waveform shaping signal Vd is less than the threshold potential Vth_U and is in a low level when the potential indicated by the waveform shaping signal Vd is equal to or greater than the threshold potential Vth_U.

The mask signal Msk is a signal which is in a high level only during a predetermined period Tmsk after the supply of the waveform shaping signal Vd from the residual vibration detecting unit 52 is started. In the present embodiment, it is possible to obtain a high-accuracy measuring signal Tc from which the superimposed noise components are removed immediately after the residual vibration starts by generating the measuring signal Tc with only the waveform shaping signal Vd after the period Tmsk elapses as a target from among the waveform shaping signals Vd.

The measuring unit 41 includes a counter (not illustrated). After the mask signal Msk falls to a low level, the counter starts to count the clock signal (not illustrated) at a time t1 which is a timing when the potential indicated by the waveform shaping signal Vd becomes equivalent to the threshold potential Vth_C for the first time. That is, after the mask signal Msk falls to the low level, the counter starts to count at a time t1 which is an earlier timing between a timing when the comparison signal Cmp1 rises to a high level for the first time and a timing when the comparison signal Cmp1 falls to a low level for the first time.

In addition, after the counter starts counting, the counter stops counting the clock signal at a time t2 which is a timing when the potential indicated by the waveform shaping signal Vd becomes the threshold potential Vth_C for the second time, and outputs the obtained count value as the measurement signal Tc. That is, after the mask signal Msk falls to the low level, the counter stops counting at a time t2 which is an earlier timing between a timing when the comparison signal Cmp1 rises to a high level for the second time and a timing when the comparison signal Cmp1 falls to a low level for the second time. In this manner, the measuring unit 41 generates the measurement signal Tc by measuring a time length from the time t1 to the time t2 as a time length corresponding to one cycle of the waveform shaping signal Vd.

In addition, when the amplitude of the waveform shaping signal Vd is small as indicated by a dashed line in FIG. 20, the possibility that the measurement signal Tc cannot be accurately measured becomes high. Moreover, when the amplitude of the waveform shaping signal Vd is small, even when it is determined that the ejection state of the ejection unit D is normal based on only the result of the measurement signal Tc, it is likely that the ejection abnormality may occur. For example, when the amplitude of the waveform shaping signal Vd is small, it is considered that the ink cannot be ejected because the ink is not injected into the cavity 320.

Here, in the present embodiment, it is determined whether the amplitude of the waveform shaping signal Vd has a magnitude sufficient to measure the measurement signal Tc to output the determination result as the effective flag Flag.

Specifically, the measuring unit 41 outputs the effective flag Flag by setting a value of the effective flag Flag to a value “1” indicating that the measurement signal Tc is effective when the potential indicated by the waveform shaping signal Vd is greater than the threshold potential Vth_O and is less than the threshold potential Vth_U and by setting the value of the effective flag to “0” in other cases during the period for which the counting is performed by the counter, that is, the period from the time t1 to the time t2. More specifically, the measuring unit 41 sets the value of the effective flag Flag to “1” when the comparison signal Cmp2 rises to the high level from the low level and then falls to the low level again and the compassion signal Cmp3 rises to the high level from the low level and then falls to the low level again during the period from the time t1 to the time t2, and sets the value of the effective flag Flag to “0” in other cases during the period.

In this manner, since the measuring unit 41 according to the present embodiment generates an effective flag Flag indicating whether the waveform shaping signal Vd has the amplitude of magnitude sufficient to measure the measurement signal Tc in addition to generating the measurement signal Tc indicating the time length corresponding to the one cycle of the waveform shaping signal Vd, it is possible to more accurately determine the ejection state of the ink in the ejection unit D.

The determination information generating unit 42 illustrated in FIG. 19 determines the ejection state of the ink in the ejection unit D based on the detection signal Tc and the effective flag Flag output by the measuring unit 41, and generates determination information RS showing the determination results.

FIG. 21 is an explanatory diagram for describing the contents of determination of the determination information generating unit 42.

As illustrated in the figure, the ejection state determining unit 42 compares the time length indicated by the measurement signal Tc with three threshold values (alternatively, any threshold value among these three threshold values) of a threshold value Tth1, a threshold value Tth2 representing a time length longer than the threshold value Tth1, and a threshold value Tth3 representing a time length longer than the threshold value Tth2.

Here, the threshold value Tth1 is a value for indicating a boundary between a time length corresponding to one cycle of the residual vibration when bubbles are generated in the cavity 320 so that the frequency of the residual vibration increases and a time length corresponding to one cycle of the residual vibration when the ejection state is normal.

Moreover, the threshold value Tth2 is a value for indicating a boundary between a time length corresponding to one cycle of the residual vibration when foreign substances such as paper dust are adhered to the vicinity of the outlet of the nozzle N so that the frequency of the residual vibration decreases and a time length corresponding to one cycle of the residual vibration when the ejection state is normal.

Moreover, the threshold value Tth3 is a value for indicating a boundary between a time length corresponding to one cycle of the residual vibration when the frequency of the residual vibration becomes further smaller than that when foreign substances such as paper dust are adhered due to fixation or thickening of the ink in the vicinity of the nozzle N and a time length corresponding to one cycle of the residual vibration when foreign substances such as paper dust is adhered to the vicinity of the outlet of the nozzle N.

As illustrated in FIG. 21, when the value of the effective flag Flag is “1” and the measurement signal Tc satisfies “Tth1≦Tc≦Tth2,” the determination information generating unit 42 determines that the ejection state of the ink in the ejection unit D is normal and sets the determination information RS to a value “1” indicating that the ejection state is normal.

Moreover, when the value of the effective flag Flag is “1” and the measurement signal Tc satisfies “Tc<Tth1,” the determination information generating unit 42 determines that the ejection abnormality occurs due to bubbles generated in the cavity 320 and sets the determination information RS to a value “2” indicating that the ejection abnormality occurs due to the bubbles.

Moreover, when the value of the effective flag Flag is “1” and the measurement signal Tc satisfies “Tth2<Tc≦Tth3,” the determination information generating unit 42 determines that the ejection abnormality occurs due to foreign substances such as paper dust adhered to the vicinity of the outlet of the nozzle N and sets the determination information RS to a value “3” indicating that the ejection abnormality occurs due to adhesion of foreign substances such as the paper dust.

Moreover, when the value of the effective flag Flag is “1” and the measurement signal Tc satisfies “Tth3<Tc,” the determination information generating unit 42 determines that the ejection abnormality occurs due to thickening of the ink in the cavity 320 and sets the determination information RS to a value “4” indicating that the ejection abnormality occurs due to the thickening of the ink.

Moreover, when the value of the effective flag Flag is “0,” the determination information generating unit 42 sets the determination information RS to a value “5” indicating that the ejection abnormality occurs due to some causes such as non-injection of the ink.

As described above, the determination information generating unit 42 determines the ejection state in the ejection unit D based on the measurement signal Tc and the effective flag Flag and generates determination information RS indicating the determination result.

The control unit 6 stores the determination information RS output by the determination information generating unit 42 in the storage unit 60 in correspondence with the number of stages of the ejection units D corresponding to the determination information RS. For this reason, it is possible to grasp which ejection unit D, from among the M ejection units D, the ejection abnormality is generated. In this manner, it is possible to perform the maintenance process at the appropriate timing in consideration of the number of ejection units D in which ejection abnormality is generated, the positions of the ejection units D in which ejection abnormality is generated, and the like. Therefore, it is possible to prevent the quality of an image to be formed by the printing process from being degraded due to ejection abnormality in the ejection unit D.

### 5. Conclusion of Embodiments

As described above, the printing signal SI is supplied in synchronization with the clock signal CL and transferred to the shift resistor SR of the subsequent stage for each cycle of the clock signal CL. Further, the potential of a wiring for supplying the print signal SI to the driving signal generating unit 51 from the control unit 6 is changed at a cycle of the clock signal CL. There is a possibility that the change of the potential accompanied by the supply of the print signal SI propagates as noise to respective units of the head driver 50 through a parasitic capacitance or the like.

In addition, the driving signal generating unit 51 to which the print signal SI is supplied, the residual vibration detecting unit 52 to which the residual vibration signal Vout is supplied, and a switching unit 53 which transmits the residual vibration signal Vout to the residual vibration detecting unit 52 are provided in the head driver 50 of the head unit 5. For this reason, the noise generated when the print signal SI is supplied propagates to the residual vibration detecting unit 52 or the switching unit 53 from the driving signal generating unit 51 and is superimposed on the residual vibration signal Vout in some cases.

The residual vibration signal Vout is a signal showing a change in the electromotive force of the piezoelectric element 300 caused by the vibration of the piezoelectric element 300 and, for example, a signal having a small amplitude compared to the driving waveform signal Com. Accordingly, in a case where the noise is superimposed on the residual vibration signal Vout, there is a possibility that the residual vibration signal Vout cannot accurately show the residual vibration caused by the ejection unit D and it is highly likely that the determination information RS generated based on the residual vibration signal Vout on which the noise is superimposed does not accurately show the ejection state of the ink in the ejection unit D.

Meanwhile, in the present embodiment, the print signal SI is supplied to the driving signal generating unit 51 during a period other than the detection period Td for detecting residual vibration generated in the ejection unit D. For this reason, even when noise is generated with the supply of the printing signal SI to the driving signal Generating unit 51, it is possible to prevent the noise from being superimposed on the residual vibration signal Vout. In this manner, the residual vibration signal Vout can accurately show residual vibration generated in the ejection unit D and thus the ejection state of the ink in the ejection unit D can be accurately determined.

Further, the waveform PB included in the driving waveform signal Com according to the present embodiment is provided for the period Tlt after detection subsequent to the detection period Td in the unit periods Tu. Accordingly, even when the waveform PB is supplied to the ejection unit D and the microvibration is generated in the ejection unit D during the unit determination operation period Tu-T, it is possible to prevent the ejection unit D which is a target of the ejection state determining process from being affected by the microvibration.

In this manner, only the residual vibration generated by driving the ejection unit D due to the waveform PT1 can be detected in the ejection unit D which is a target of the ejection state determining process and superimposition of the noise on the residual vibration itself can be prevented. Accordingly, the ejection state of the ink in the ejection unit D can be accurately determined.

Moreover, the control unit 6 functions as a “supply unit” by performing a process of supplying the print signal SI to the driving signal generating unit 51. That is, the supply unit is a functional block realized by the control unit 6 being operated according to a control program.

### B. MODIFICATION EXAMPLES

The above-described respective aspects may be variously modified. Aspects of specific modifications will be exemplified below. Two or more aspects which are randomly selected from the following exemplified modifications may be appropriately combined with each other within the scope without mutual conflict.

In addition, in Modification Examples described below, elements whose operations and functions are the same as those in the embodiments are denoted by the same reference numerals described above and the description thereof will not be repeated.

### Modification Example 1

In the embodiments described above, the control unit 6 provides a print signal transfer period Tfw during the period Tlt after detection which is a period subsequent to the detection period Td in the unit determination operation period Tu-T and supplies the print signal SI to the driving signal generating unit 51 during the print signal transfer period Tfw, but the invention is not limited thereto. The print signal transfer period Tfw may be provided in an arbitrary period other than the detection period Td.

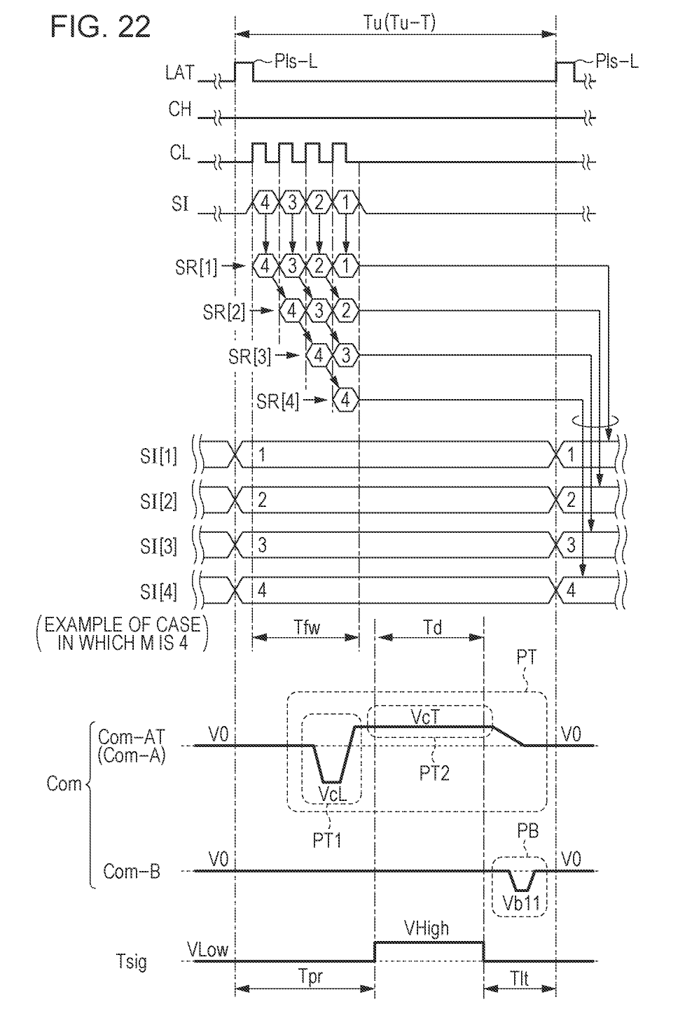

For example, as illustrated in FIG. 22, the print signal transfer period Tfw may be provided in the period Tpr before detection. In the case where the print signal transfer period Tfw is provided in the period Tpr before detection as illustrated in FIG. 22, it is possible to lengthen the time length from when the unit period Tu is started to when the detection period Td is started compared to a case (see FIG. 17) where the print signal transfer period Tfw is provided in the period Tlt after detection. Accordingly, in a case where the residual vibration of the ejection unit D[m] is detected during one unit period Tu, it is possible to minimize vibration generated in the ejection unit D[m] during the preceding unit period Tu to when the detection period Td of the one unit period Tu is started (alternatively, a time at which the waveform Pt1 with respect to the ejection unit D[m] starts to be supplied) even when the ejection unit D[m] is driven and vibration is generated during the unit period Tu preceding the one unit period Tu. Therefore, according to the embodiment shown by FIG. 22, the ejection state of the ink in the ejection unit D can be easily and accurately determined.

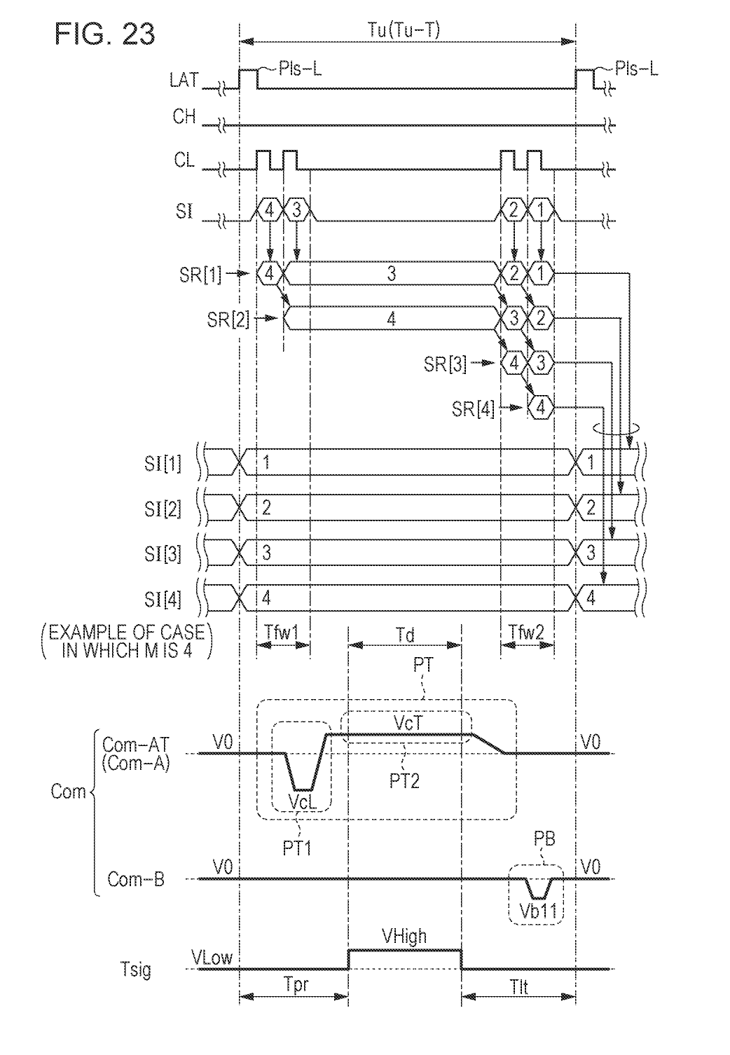

In addition, as illustrated in FIG. 23, the print signal transfer period Tfw may be provided in both of the period Tpr before detection and the period Tlt after detection. Specifically, the control unit 6 may supply the print signal SI during both periods of the print signal transfer period Tfw1 provided in the period Tpr before detection and the print signal transfer period Tfw2 provided in the period Tlt after detection.

In a case where the print signal transfer period Tfw is provided in both of the period Tpr before detection and the period Tlt after detection, it is possible to lengthen the time length of the print signal transfer period Tfw compared to the case where the print signal transfer period Tfw is provided in one of the period Tpr before detection and the period Tlt after detection. For this reason, for example, the print signal SI can be easily supplied even when the number of ejection units D is large and the time required to supply the print signal SI is long or when the print speed is high and the time length of the unit period Tu is short. That is, according to the mode illustrated in FIG. 23, it is possible to increase the number of ejection units D and to supply the print signal in response to the speed up of the print signal.

### Modification Example 2

In the above-described embodiments and Modification Examples, the ejection state determining process is performed only during the unit determination operation period Tu-T and the ejection state determining process is not performed during the unit print operation period Tu-P, but the invention is not limited thereto and the ejection state determining process may be performed during the unit print operation period Tu-P.

For example, the waveform PA1 is supplied as the driving waveform signal Com-AP during the unit print operation period Tu-P illustrated in FIG. 16, a part of the period for which a potential of the driving waveform signal Com-AP for printing maintains the maximum potential Va12 is set as a detection period Td, and the residual vibration of the ejection unit D during the detection period Td may be detected. In this case, the print signal transfer period Tfw may be provided in a period other than the detection period Td, for example, a period to which the waveform PA2 is supplied as the driving waveform signal Com-AP for printing.

### Modification Example 3

The ink jet printer 1 according to the above-described embodiments and Modification Examples includes one residual vibration detecting unit 52 and one ejection state determining unit 40 and performs the ejection state determining process on one target ejection unit D during one unit period Tu, but the invention is not limited thereto. In addition, the ink jet printer 1 may have a configuration in which the ejection state determining process can be performed on two or more ejection units D during one unit period Tu.

For example, the ink jet printer 1 may have a configuration in which a plurality of residual vibration detecting units 52 are included and the residual vibration signals Vout from the plurality of ejection units D can be detected at the same time during each unit period Tu. Further, in this case, it is preferable that the ejection state determining unit 40 can determine the ejection state of the ink in the plurality of ejection units D based on a plurality of waveform shaping signals Vd output by the plurality of residual vibration detecting units 52. For example, the ejection state determining unit 40 may include a plurality of measuring units 41 and a plurality of determination information generating units 42 corresponding to the plurality of residual vibration detecting units 52.

### Modification Example 4

In the above-described embodiments and Modification Examples, the ejection state determining unit 40 is implemented as an electronic circuit, but the invention is not particularly limited. A part or the entire ejection state determining unit 40 may be implemented as a functional block realized by the control unit 6 executing the control program of the ink jet printer 1.

Specifically, the entire ejection state determining unit 40, that is, the measuring unit 41 and the determination information generating unit 42 may be implemented as a functional block to be realized by the control unit 6. In addition, for example, the determination information generating unit 42 in the ejection state determining unit 40 may be implemented as a functional block to be realized by the control unit 6. In these cases, the control unit 6 functions as a “determining unit” that determines the ejection state of the ink in the ejection unit D.

### Modification Example 5

The ink jet printer 1 according to the above-described embodiments and the Modification Examples is a line printer for which the nozzle array Ln is provided such that the area YNL includes the area YP, but the present invention is not limited thereto. The ink jet printer 1 may be a serial printer in which the recording head 30 reciprocates in the Y axis direction and performs the printing process.

### Modification Example 6

The ink jet printer 1 according to the above-described embodiments and Modification Examples divides one sheet of long recording paper P into Wcp printing areas and a margin area that partitions the printing areas and forms Wcp images in one-to-one correspondence with the Wcp printing areas in the case of performing the printing process, but the invention is not limited thereto. The ink jet printer 1 may form one image on the whole recording paper P.

In this case, for example, the recording paper P may have a square shape such as A4-size paper. Further, in this case, the transport mechanism 7 may supply a plurality sheets of recording paper P to the platen 74 intermittently when the printing process is performed and one image may be formed on one sheet of recording paper P supplied to the platen 74. Further, in this case, it is preferable that the ink jet printer 1 performs the ejection state determining process during a period (that is, a period for which the recording paper P is not present on the platen 74) from when one sheet of recording paper P is transported to the platen 74 to when different recording paper P is supplied to the platen 74 for the first time after the one sheet of recording paper P.

### Modification Example 7

The ink jet printer 1 according to the above-described embodiments and Modification Examples can eject four colors of CMYK inks, but the invention is not limited thereto. The ink jet printer 1 may eject at least one color of ink or eject a color other than the four colors of CMYK inks.

Further, the ink jet printer 1 according to the above-described embodiments and Modification Examples include at least four ejection units D in the recording head (that is, M≧4), but the invention is not limited thereto. The ink jet printer 1 may include at least one ejection unit D (that is, M may represent a natural number of 1 or higher).

### Modification Example 8

In the above-described embodiments and Modification Examples, the driving waveform signal Com includes the driving waveform signals Com-A and Com-B, but the invention is not limited thereto. The driving waveform signal Com may be a single signal, for example, a signal including only the driving waveform signal Com-A or may be formed of three or more signals, for example, a signal including the driving waveform signals Com-A, Com-B, and Com-C.

Further, the above-described embodiments and Modification Examples, the driving waveform signal Com includes a plurality of waveforms, but may be a signal including at least one waveform. For example, the driving waveform signal Com is formed of only the driving waveform signal Com-A or the driving waveform signal Com-A may be formed only the waveform PA1 (see FIG. 16).

In addition, the driving signal generating unit 51 supplies the driving waveform signal Com to the ejection unit D as the driving signal Vin in a case where the ink is ejected from the ejection unit D or the ejection state of the ink in the ejection unit D is determined. Further, the driving signal generating unit may be operated so as to maintain the potential of the driving signal Vin, which is to be supplied to the ejection unit D, to be constant by selecting the driving waveform signal Com in a case where the ink is not ejected from the ejection unit D.

In addition, in the above-described embodiments and Modification Examples, the print signal SI[m] is a 2-bit signal, but the number of bits of the print signal SI[m] can be suitably determined according to the gradation to be displayed, the number of control periods Is included in the unit periods Tu, and the number of signals included in the driving waveform signal Com.

### Modification Example 9

In the above-described embodiments and Modification Examples, the head driver 50 includes one driving signal generating unit 51 and a single kind of driving waveform signal Com is supplied to the driving signal generating unit 51, but the invention is not limited thereto. The head driver 50 may include a plurality of driving signal generating units 51 provided for each color of ink to be ejected from the ejection unit D and the control unit 6 may supply plural kinds of driving waveform signals Com in one-to-one correspondence with the plurality of driving signal generating units 51 to the head driver 50.

What is claimed is:

1. A liquid ejecting device comprising:
an ejection unit that includes a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber;
a generating unit that generates the driving signal based on a driving waveform signal having one or a plurality of waveforms and a designation signal designating a waveform to be supplied to the piezoelectric element from one or the plurality of waveforms included in the driving waveform signal;
a supply unit that supplies the designation signal to the generating unit for each unit period;
a detecting unit that detects residual vibration generated in the ejection unit after the piezoelectric element is shifted according to the driving signal; and
a determining unit that determines an ejection state of the liquid in the ejection unit based on the detection results of the detecting unit,
wherein the detecting unit detects the residual vibration during a detection period in the unit period, and
the supply unit supplies the designation signal to the generating unit during a period other than the detection period in the unit period.

2. The liquid ejecting device according to claim 1, wherein the supply unit supplies the designation signal to the generating unit during a first period which is a period after the detection period in the unit period is finished.

3. The liquid ejecting device according to claim 2,
wherein, when supplied to the piezoelectric element, the driving waveform signal includes a microvibration waveform that shifts the piezoelectric element to the extent that the liquid cannot be ejected from the nozzle, and
the microvibration waveform is provided during the first period.

4. The liquid ejecting device according to claim 1,
wherein the supply unit supplies the designation signal to the generating unit during a second period which is a period before the detection period in the unit period is started.

5. The liquid ejecting device according to claim 1, wherein the supply unit supplies the designation signal to the generating unit during a first period which is a period after the detection period in the unit period is finished and during a second period which is a period before the detection period in the unit period is started.

6. A method of controlling a liquid ejecting device which includes an ejection unit including a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber; and a generating unit that generates the driving signal based on a driving waveform signal having one or a plurality of waveforms and a designation signal designating a waveform to be supplied to the piezoelectric element from one or the plurality of waveforms included in the driving waveform signal, the method comprising:
supplying the designation signal to the generating unit for each unit period;
detecting residual vibration generated in the ejection unit after the piezoelectric element is shifted according to the driving signal; and
determining an ejection state of the liquid in the ejection unit based on the detection results of the residual vibration,
wherein the detecting of the residual vibration is performed during a detection period in the unit period, and
the supplying of the designation signal is performed during a period other than the detection period in the unit period.

7. A control program of a liquid ejecting device which includes an ejection unit including a piezoelectric element which is shifted according to a driving signal, a pressure chamber whose inside is filled with a liquid so that the pressure in the inside is decreased or increased due to the shift of the piezoelectric element, and a nozzle that communicates with the pressure chamber and ejects a liquid which fills the inside of the pressure chamber in response to the decrease or the increase in the pressure in the inside of the pressure chamber; a generating unit that generates the driving signal based on a driving waveform signal having one or a plurality of waveforms and a designation signal designating a waveform to be supplied to the piezoelectric element from one or the plurality of waveforms included in the driving waveform signal; a detecting unit that detects the residual vibration generated in the ejection unit after the piezoelectric element is shifted according to the driving signal; and a computer, the program causing the computer to function as:
a supply unit that supplies the designation signal to the generating unit for each unit period; and
a determining unit that determines an ejection state of the liquid in the ejection unit based the detection results of the detection unit,
wherein the detecting unit detects the residual vibration during a detection period in the unit period, and
the supply unit supplies the designation signal to the generating unit during a period other than the detection period in the unit period.
